(19) United States
(12) Patent Application Publication
(10) Pub. No.: US 2005/0049954 A1
(43) Pub. Date: Mar. 3, 2005

(54) Portfolio compliance managing techniques

(76) Inventors: Russell J. Graham, Wheaton, IL (US); David A. Rieger, Warrenville, IL (US); Matthew R. Treter, Naperville, IL (US); Jonathan J. Volle, Wheaton, IL (US)

Correspondence Address: MCANDREWS HELD & MALLOY, LTD, 500 WEST MADISON STREET, SUITE 3400, CHICAGO, IL, 60661, US

(21) Appl. No.: 10/934,976

(22) Filed: Sep. 3, 2004

Related U.S. Application Data
(60) Provisional application No. 60/499,840, filed on Sep. 3, 2003.

(51) Int. Cl. G06F 17/60

(52) U.S. Cl. 705/36

(57) ABSTRACT

A computer and Internet based system and method for managing portfolios of various securities, especially fixed income securities, is provided. This system and method enables the defining of the various investment goals and strategies for the portfolios and enables the evaluation of the suitability of potential purchases and/or sales of securities related to the portfolios, preferably with a menu driven system. The system and method combines portfolio modeling and analytics with tools that connect investment managers to buyers and sellers in fixed income securities markets. The integration of decision-making analytics with bond market access creates a more efficient way to manage, buy and/or sell fixed income securities.

### RELATED APPLICATIONS

Priority is claimed from provisional application U.S. Ser. No. 60/499,840, filed Sep. 3, 2003, now pending. The entire specification and all the claims of the provisional application referred to above are hereby incorporated by reference to provide continuity of disclosure.

### BACKGROUND OF THE INVENTION

This invention relates to a system and method for managing portfolios of various securities, especially fixed income securities. This system and method enables the defining of the various investment goals and strategies for the portfolios and enables the evaluation of the suitability of potential purchases and/or sales of securities related to the portfolios, preferably with a menu driven system.

Bonds and notes, debt instruments issued by government entities and corporations to raise capital, are known as fixed income securities. They typically have a fixed rate of interest payment, a set redemption value, and a specified date of maturity. They vary widely in terms of the their credit quality, structure, and sensitivity to interest rate environment changes. Buyers and sellers in the fixed income securities market, such as managers of fixed income portfolios, deal with many challenges that are absent from the more familiar equity markets and exchanges. For the vast majority of fixed income securities, there is no centralized market or exchange. Instead, trading is done on what is known as an over-the-counter basis, with buyers and sellers indicating inquiries and offerings, and typically negotiating the price for each trade, the telephone being the primary tool used to execute transactions. Therefore, the traditional approach to buying and selling fixed income securities such as municipal bonds, U.S. treasury bonds and corporate bonds, is inefficient.

Unlike the equity exchanges and networks, where a buyer can generally find a liquid market with current bid and ask prices for a given security, a participant in the fixed income market may not be able to find a specific security offered for sale. Securities offered in the market need to be individually evaluated, as the number of unique securities is very large. The price of a security may be dependent on the quantity traded, requiring some market participants to consider combining trades for multiple accounts to obtain best price execution. These factors result in unique challenges to efficient securities trading within the fixed income market.

Managers of portfolios of fixed income securities often are responsible for making buy and sell decisions to maximize the performance of portfolios, while complying with prescribed portfolio composition goals and constraints. Many factors create challenges to successful management, such as market dynamics that impact current portfolio holdings, adjustments to the prescribed guidelines on portfolio composition and goals, changes in current portfolio holdings' attributes that occur normally with the passage of time, difficulty in locating appropriate securities in the market once desired security characteristics have been determined, and the need to monitor and manage many portfolios simultaneously. Furthermore, the portfolio targets and constraints for the set of portfolios being managed are often not uniform. Although it may be possible to group portfolios with like characteristics together, unique requirements may still exist on a portfolio-by-portfolio basis.

When it comes to evaluating the impact of a proposed change to a portfolio resulting from a purchase (addition) or sale (removal) of a security, there are many measures of the resulting change to the aggregate portfolio characteristics that may be relevant to the manager. For a given proposed change, some measures may be improved with respect to goals and limits, while others are negatively impacted. A means of measuring the impacts to the various measures in a standard and comparable fashion would make it possible to assign an overall measure of the appropriateness of a proposed change.

Due to the nature of the fixed income security market, where the transaction quantity may have significant impact on price and availability of a security, portfolio managers may often need to consider a purchase or sale that impacts multiple portfolios. Managers also need to discriminate among multiple securities offerings in a timely fashion. Therefore, what is needed is a means to quickly determine, for multiple portfolios, the overall impact on the corresponding goals and limits that would result from various proposed changes, and to be able to compare and contrast numerous potential changes efficiently, in order to determine and execute the best portfolio management decisions.

The market has changed in recent years; technology now allows dealers and customers to interact through electronic media. One of the greatest factors contributing to the increased popularity of electronic trading has been the phenomenal growth of the Internet, allowing connectivity among nearly all market participants.

The popularity of electronic systems has resulted in a dilemma for market participants. There are numerous trading systems for the fixed income market, overwhelming both buyers and sellers with too many technology choices. As a result, there is a need for software applications that can provide a centralized marketplace for buying and selling fixed income securities, and can support the buy/sell process and serve as an intermediary between buyers and sellers to facilitate the distribution of fixed income securities.

Various solutions currently exist for the analysis of portfolios of fixed income securities. These includes software applications and information services that allow the computation and display of various measures of aggregate portfolio characteristics, the graphical display thereof, and analysis of the before-and-after results of purchases, sales, and swaps. Various sophisticated forms of quantitative analysis and statistical techniques of risk management are also in use, using back-testing of strategies on historical market data to attempt to identify promising current investment strategies.

Existing products on the market require buyers to alter their process and the way they do business. Therefore, there is a need for a product that can create an efficient electronic environment that support market participants' existing processes and emulate their current business practices, for example emulates the over-the-counter fixed income market.

The benefit that this invention uniquely provides is the combination of portfolio analytic measures with a composite measure of the impact of proposed transactions, based on a system of “bond type” and “portfolio compliance model” definitions, to allow the efficient assessment and comparison of trading alternatives.

### BRIEF SUMMARY OF THE INVENTION

The system and method of the present invention combines portfolio modeling and analytics with tools that connect investment managers to buyers and sellers in the securities markets, especially in the market of fixed income securities such as bonds. The integration of decision-making analytics with bond market access creates a more efficient way to buy and sell bonds.

One object of the present invention is to increase trading efficiencies by facilitating the communication between “buy-side” and “sell-side” market participants.

Another object of the present invention is to provide an interface to the fixed income marketplace by enabling a user to interact with other market participations, wherein the interface can allow the user to search and receive offerings and sell holdings.

A further object of the present invention is to allow investment managers to define investment/compliance models based on a broad array of both individual security attributes as well as overall portfolio measures. For example, these models can allow managers to define multiple regions within the fixed income space as defined by bond characteristics as either acceptable or unacceptable investments for the portfolios managed under that model.

Still another object of the present invention is to allow users to create any number of investment/compliance models, and assign security portfolios to the models as appropriate. In one embodiment, these models can serve to define the investment strategy for assigned portfolios in terms of requirements, goals and restrictions.

Yet another object of the present invention is to allow users to search in the marketplace to identify appropriate offerings that meet the requirements defined within the investment/compliance model.

Still a further object of the present invention is to provide a tool having a scoring mechanism based on user-defined investment/compliance models, allowing efficient impact analysis of potential purchases or sales on multiple fixed income security portfolios. For example, in one embodiment, the present invention enables the user to efficiently identify which portfolios and associated allocations provide the greatest positive impact from the potential purchase or sale.

There is another object of the present invention to allow the user to define positive impact criteria within the investment model, and may include exposure criteria for various investment risks, and target attributes for the portfolio as a whole. In one embodiment of the present invention, the impact of each aspect of the model to the score for a potential purchase or sale can be calibrated by the user to tune the model definitions.

In one aspect, the present invention provides a method for a use utilizing a computer to manage portfolios of fixed income securities. The method of this aspect of the present invention includes steps of:
(1) creating one or more accounts by using the computer, wherein each account includes one or more fixed income security holdings;
(2) creating an investment model by using the computer, wherein the investment model is defined by a set of first parameters;
(3) assigning the one or more accounts to the investment model by using the computer;
(4) determining aggregate measures of characteristics of the security holdings in a selected account of the one or more accounts;
(5) correlating the set of first parameters with the aggregate measures of the characteristics of the security holdings in the selected account and characteristics of each of the security holdings in the selected account;
(6) generating in response to the correlating step measures of correlation by using the computer; and
(7) displaying indicia of the measures of correlation by using the computer.

In another aspect, the present invention provides a method and a computer executable portfolio compliance software application for a user to manage portfolios of fixed income securities, wherein the software application includes a set of instructions that when executed by a computer enable the user to:
(1) create an investment model, wherein the investment model is defined by a set of first parameters;
(2) create a plurality of accounts, wherein each of the plurality of accounts comprises one or more fixed income security holdings, wherein each of the plurality of accounts is defined by a set of second parameters; and
(3) assign one or more of the plurality of accounts to the investment model.

The computer executable portfolio compliance software application of the present invention can further enable the user to identify appropriate fixed income securities offered for sale in a market or appropriate fixed income security holdings to be offered for sale out of the accounts.

The computer executable portfolio compliance software application of the present invention can further enable the user to propose, negotiate or execute a purchase or sale of a fixed income security.

### BRIEF DESCRIPTION OF SEVERAL VIEWS OF THE DRAWINGS

FIG. 1a is a schematic block diagram illustrating an electronic trading system showing one embodiment of the invention.

FIG. 1b is a schematic block diagram illustrating an exemplary personal computer system connected to a computer communication network, which is of the type used in the computer systems shown in FIG. 1a.

FIGS. 2a-2l are screen displays of an exemplary portfolio compliance software application illustrating various embodiments of the present invention.

### DETAILED DESCRIPTION OF THE INVENTION

The following detailed description illustrates the invention by way of example, not by way of limitation, of the principles of the invention. This description will clearly enable one skilled in the art to make and use the invention, and describes several embodiments, adaptations, variations, alternatives and uses of the invention, including what are presently believed to be the best modes of carrying out the invention.

Investment managers of portfolios of fixed income securities have varied perspectives on which types of portfolio information and measures are the most important from a portfolio management perspective. Applicants have recognized that there is a need for systems, means, computer software applications and methods that measures compliance of portfolios against investment models, creates a combined inquiry by aggregating need, and allocates to accounts based on investment objectives.

The present invention relates to a method and system for managing portfolios of securities, for example, fixed income securities such as municipal bonds. The method and system of the present invention can provide great flexibility in the definition of security types and portfolio models to support the portfolio analysis and management process.

In the following description, for the purposes of explanation, numerous specific details are set forth in order to provide a thorough understanding of the present invention. It will be apparent, however, to one skilled in the art that the present invention may be practiced without some of these specific details.

The present invention includes various steps, which will be described below. At least some of the steps of the present invention may be embodied in machine-executable instructions. The instructions can be used to cause a general-purpose or special-purpose processor which is programmed with the instructions to perform the steps of the present invention. Alternatively, the steps of the present invention may be performed by specific hardware components that contain hardwired logic for performing the steps, or by any combination of programmed computer components and custom hardware components.

While, embodiments of the present invention will be described with reference to a Portfolio Compliance Manager™ (PCMan) software tool developed by BondWave LLC (Lisle, Ill.), the method and system described herein are equally applicable to other types of investment software applications, involving different kinds of securities.

### System Overview

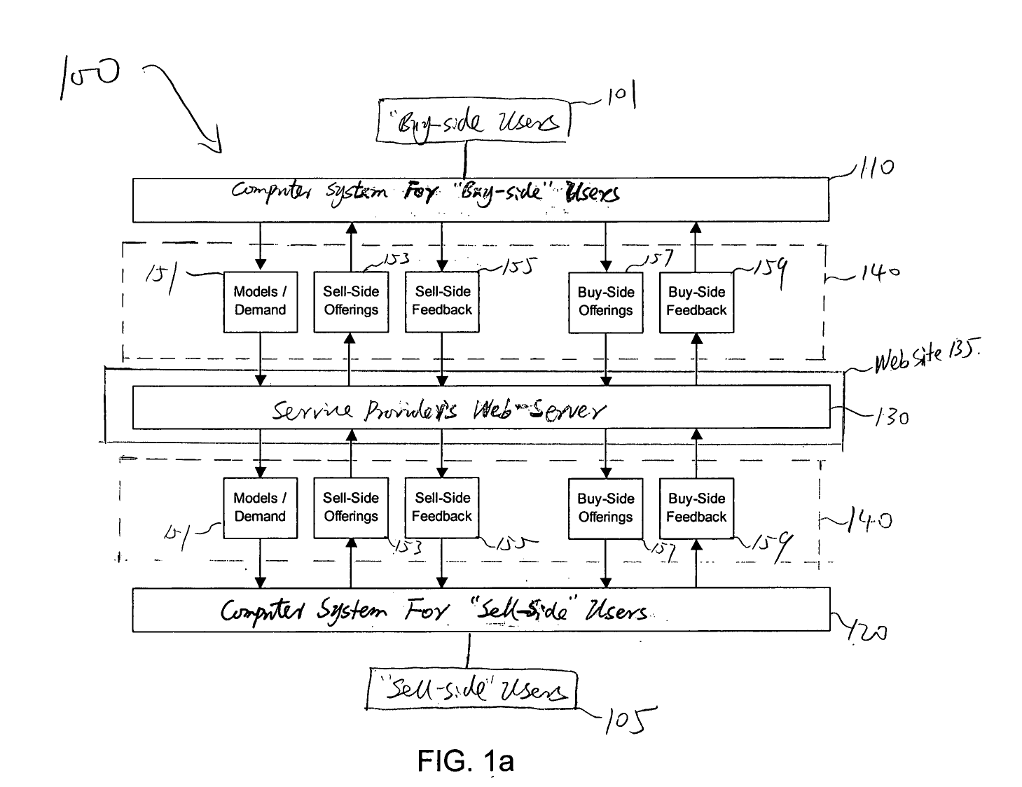

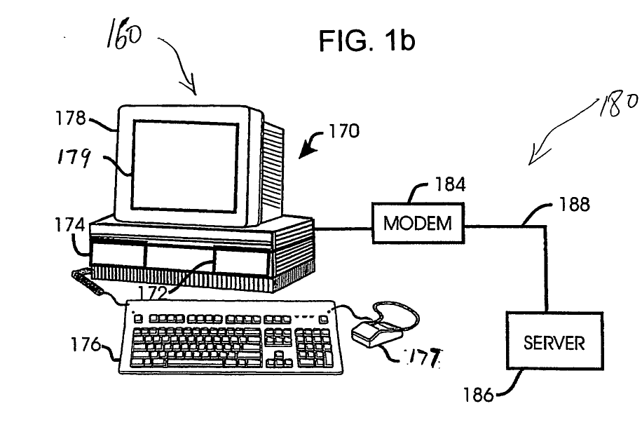

The present invention may be included within a client-server based electronic trading system 100 such as that illustrated in FIG. 1a. The electronic trading system 100 allows a buy-side user 101 and a sell-side user 105 to electronically communicate to each other and exchange information vital to the flow of market activity using personal computer systems 110 and 120 through a trading system service provider's web-server 130. The users' computers systems 110 and 120 and the web-server 130 are all linked to a computer communication network, such as Internet 140. The web-server provides a website 135 on Internet 140, and are accessible by users 101 and 105 using computer systems 110 and 120 through conventional web access controls and techniques.

By way of illustration, buy-side users 101 can be institutions like trust departments and investment managers that are responsible for the buying, selling, and overall management of their clients' accounts. Sell-side users 105 can be fixed income securities broker/dealers which maintain an inventory of securities which they market to the buy-side users.

FIG. 1a also schematically illustrates the type of information that can be exchanged between users through the use of electronic trading system 100 employing the present invention. Referring to FIG. 1a, the information may include models and/or demand information 151, sell-side offerings 153, sell-side feedback 155, buy-side offerings 157, and buy-side feedback 159. For example, software applications installed in computer system 110, which include the compliance software application employing the present invention, allow user 101 to communicate its demand needs into the environment of system 100, and allow user 105 to respond with an appropriate supply of bonds. User 105 can electronically direct specific offerings to user 101, and user 101 can electronically purchase from or negotiate price and quantity with user 105 via Internet 140 through the service provider's web-server 130 and its website 135.

In one embodiment of the present invention, it provides an integrated compliance software application allowing a user such as user 101 of the electronic trading system 100 to create models and accounts, assign models to accounts, and establish an investment strategy for those accounts. In this written description, accounts are clients' security portfolios, and models represent investment strategies. In accordance with one embodiment of the present invention, the compliance software application installed in the users' computers can measure compliance of portfolios against investment models, create a combined inquiry by aggregating need, and allocate to accounts based on investment objectives. For example, user 101 can monitor the account's compliance to its associated model. User 101 can also run different account scenarios and benchmark analyses, and communicate the aggregated demand across his accounts to user 105.

FIG. 1b illustrates an exemplary personal computer system 160 of the type used in computer systems 110 and 120 of FIG. 1a, which is connected to a computer communication network 180. The personal computer system 160 comprises a personal computer 170 as the system hardware and all the software applications (not shown) installed in the personal computer 170. The personal computer 170 includes a central processing unit 172 and a memory 174. Data can be entered into the memory by a user via a conventional keyboard 176. The entry and manipulation of data can be enhanced by use of a conventional computer mouse 177. Memory 174 stores instructions and software applications that cause data to be processed and to be displayed as screen displays on a conventional display monitor 178 having a display face 179. The instructions include a plurality of algorithms that enable efficient management of security inquiries.

Still referring to FIG. 1b, data can be uploaded or downloaded from or to the personal computer 170 by an application program interface (API) (not shown) via a network connection device 184 to or from a server computer 186 within the computer communication network 180 at a location remote from the location of computer 170. The network connection device 184 can include, for example, a modem and/or router, which connects the personal computer to the server computer 186 that stores data in a database through a network 188, such as the Internet. The data downloading or uploading can be done by using one or more software applications installed in the personal computer 170, with results displayed, for example, via web browser without undue experimentation.

### An Exemplary Portfolio Compliance Software Application

Having briefly described one embodiment of the electronic trading system 100 that includes a web-server 130 and one or more personal computer systems installed with the portfolio compliance software application, the method and system of the present invention will now be described in relation to an exemplary compliance software application, i.e., the PCMan software tool developed by BondWave LLC (Lisle, Ill.), in which features of the present invention may be implanted.

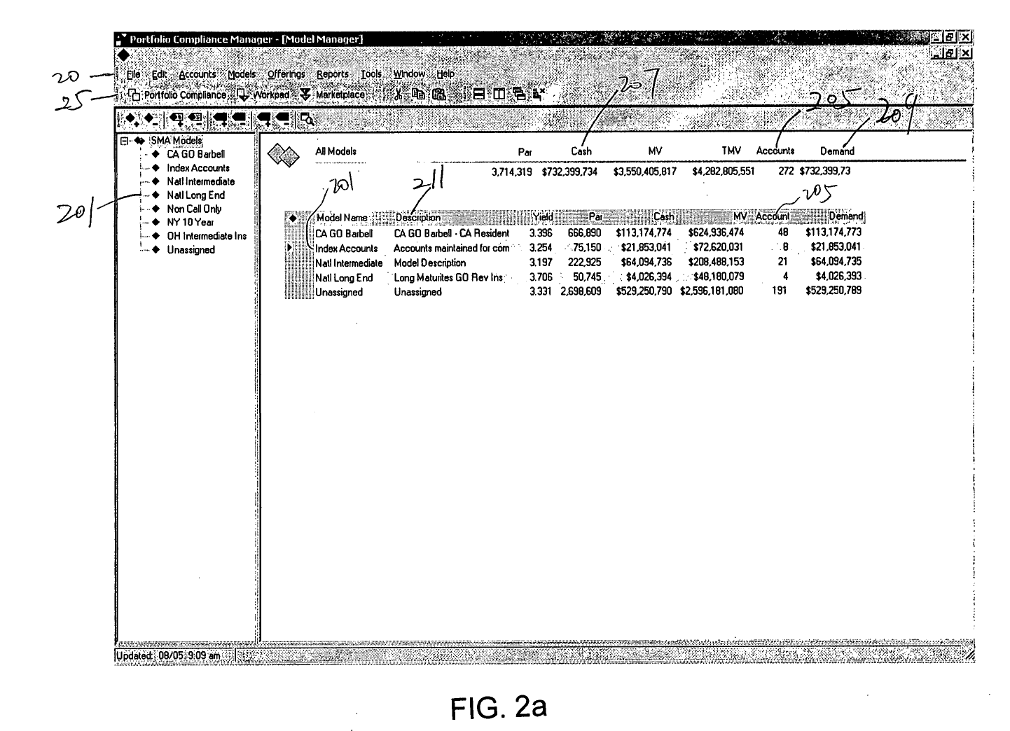

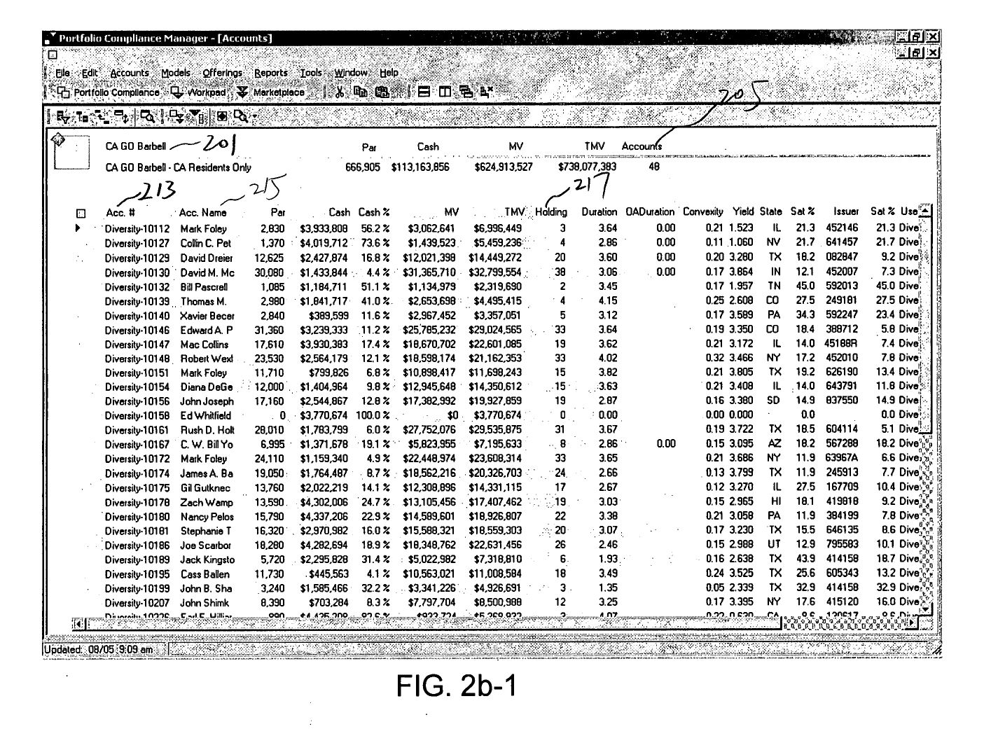

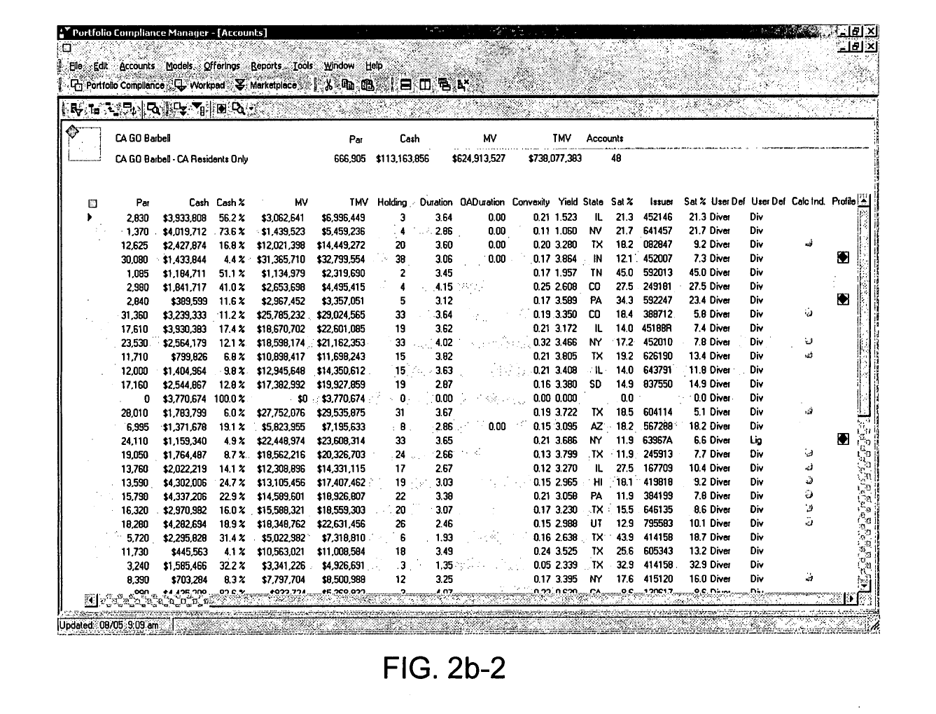

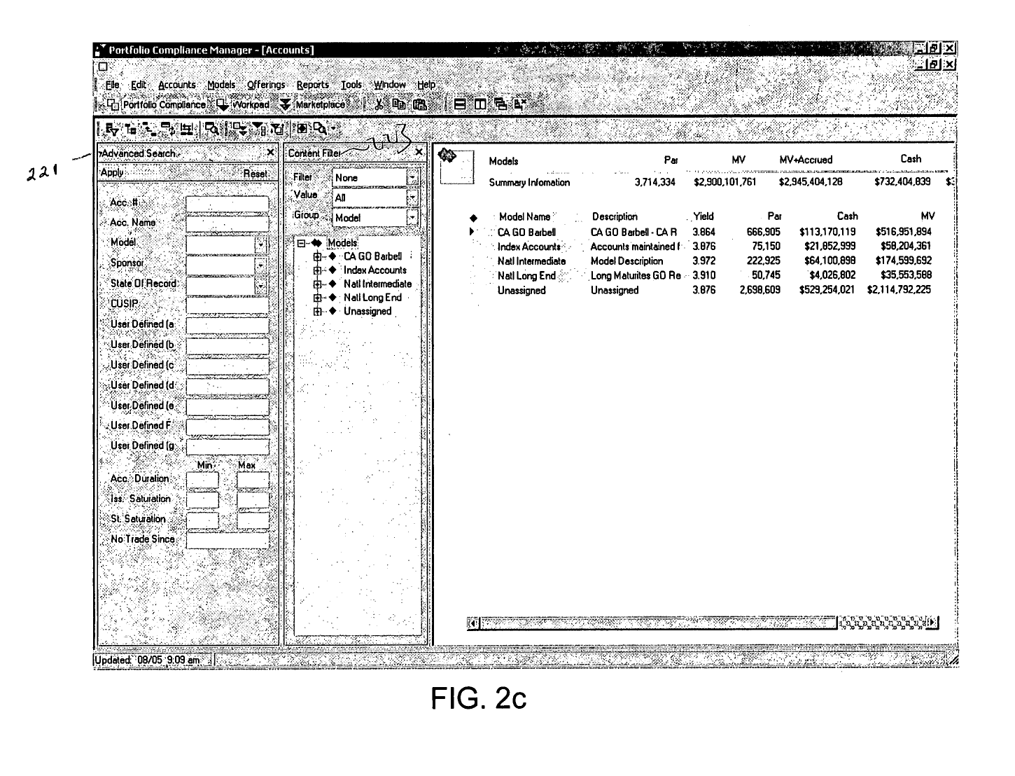

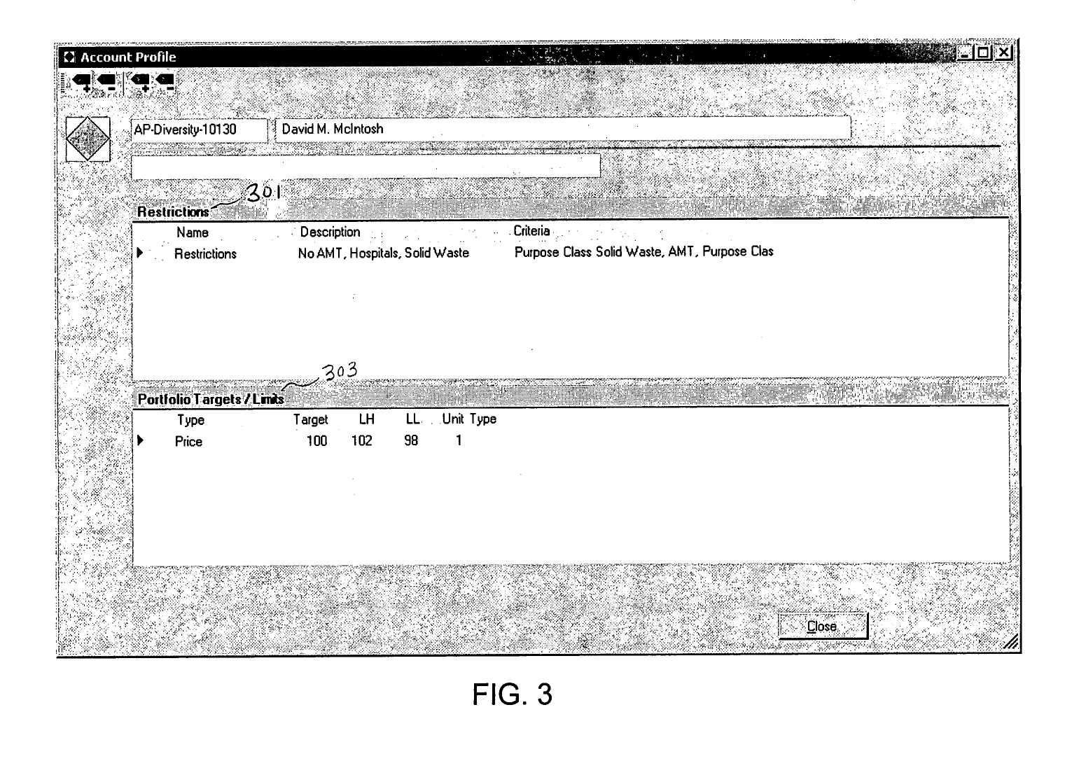

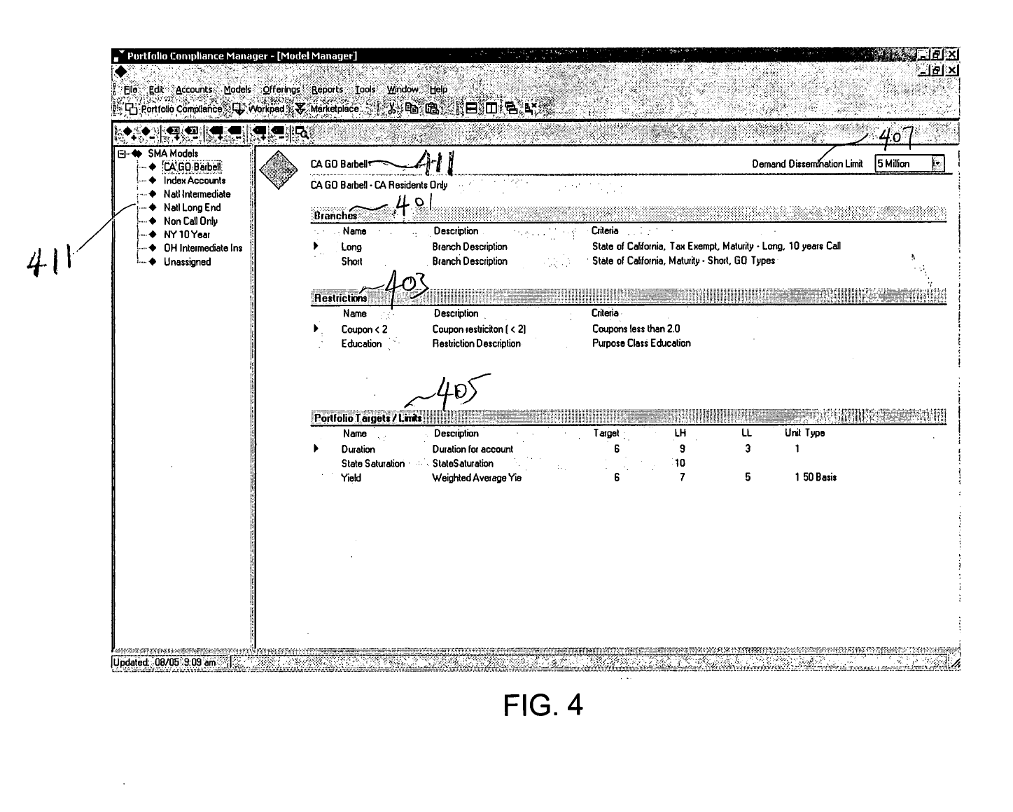

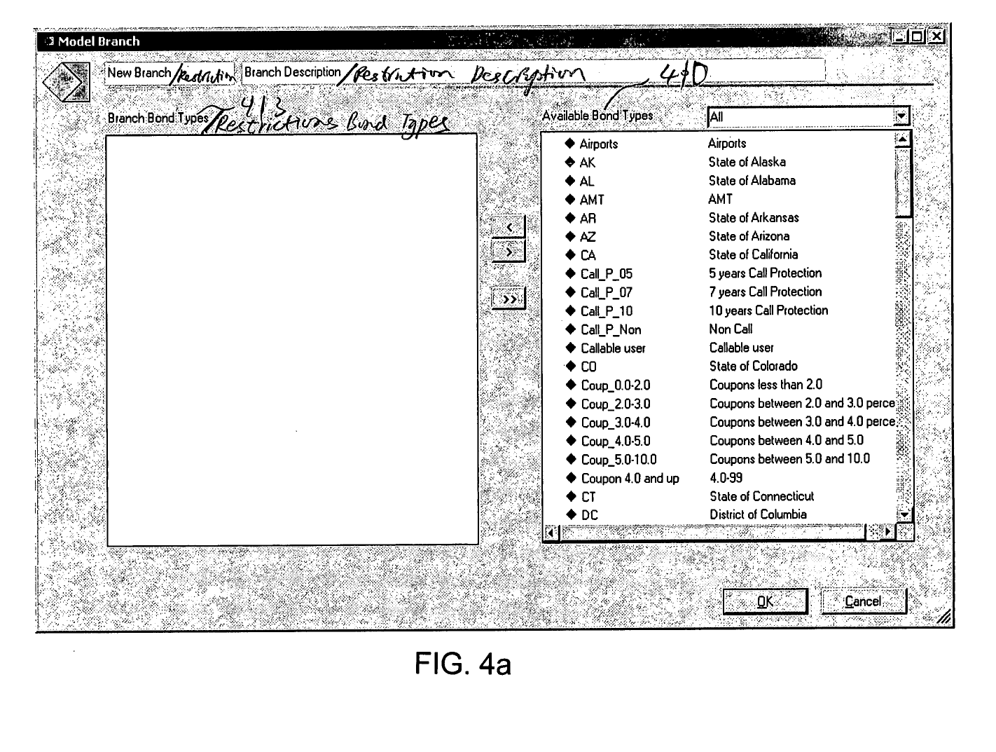

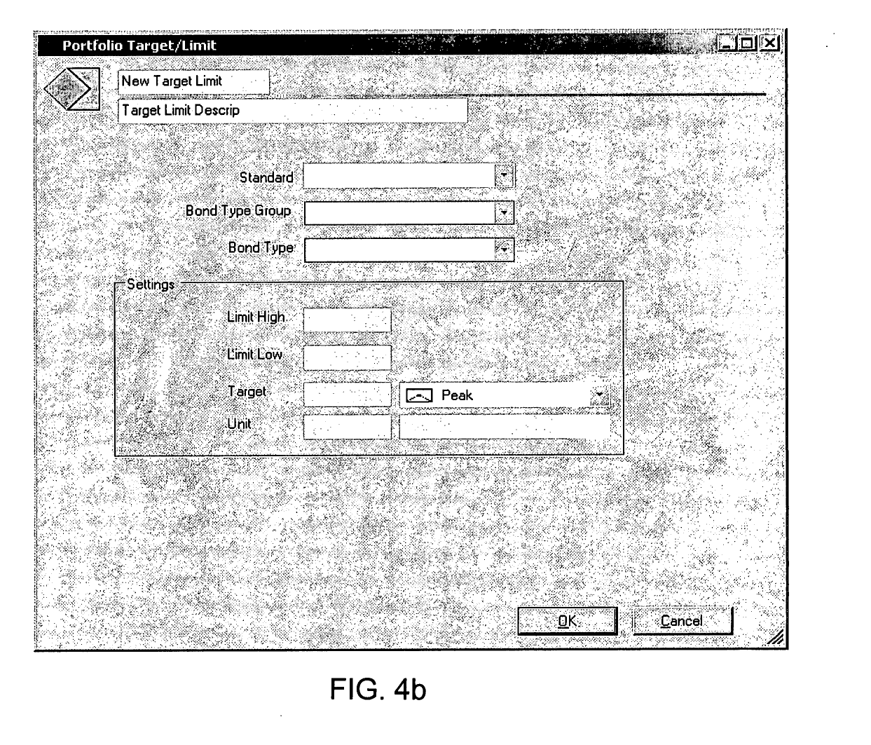

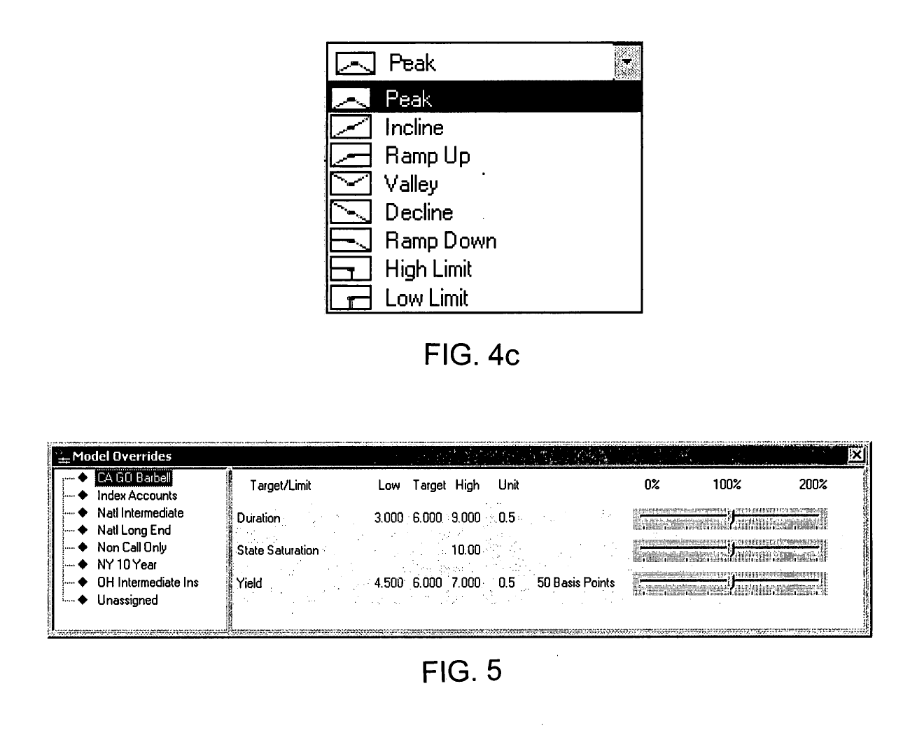

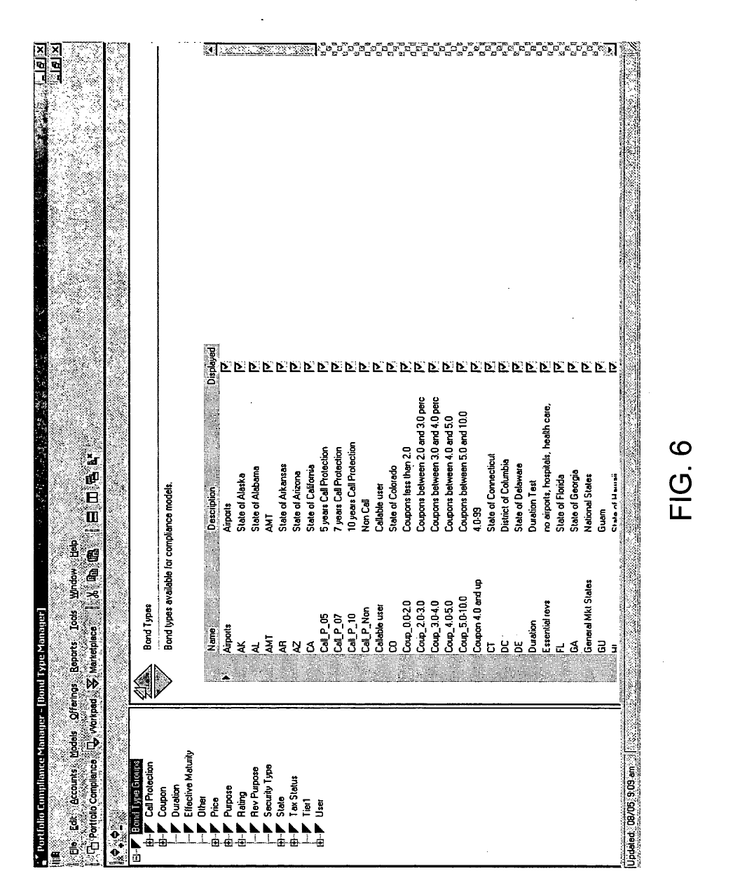

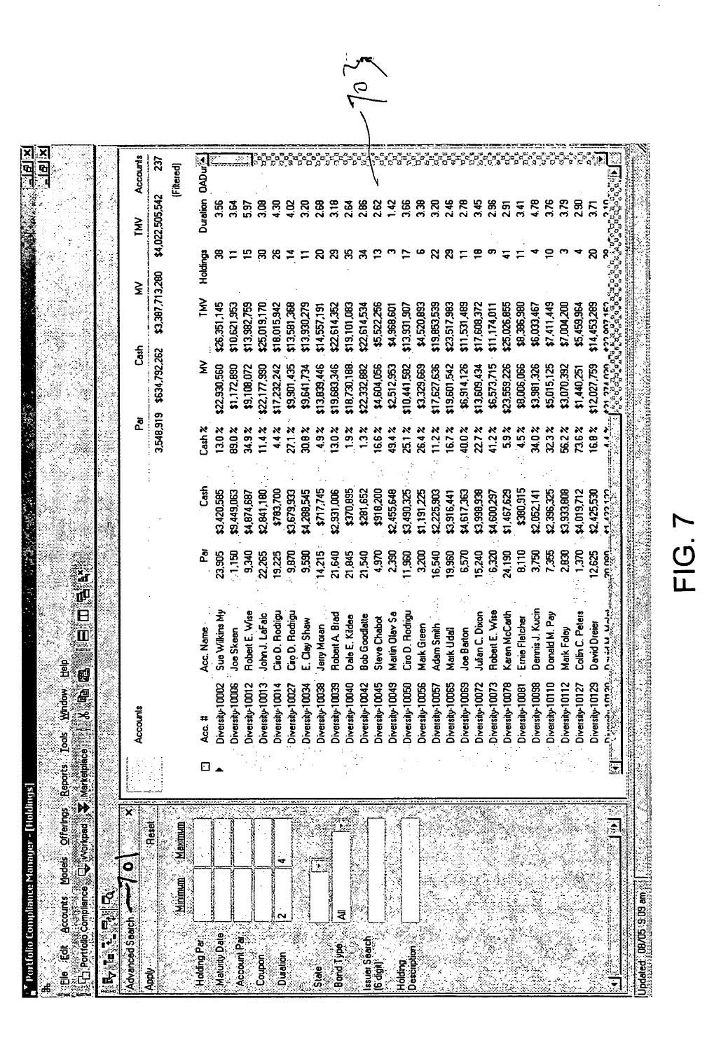

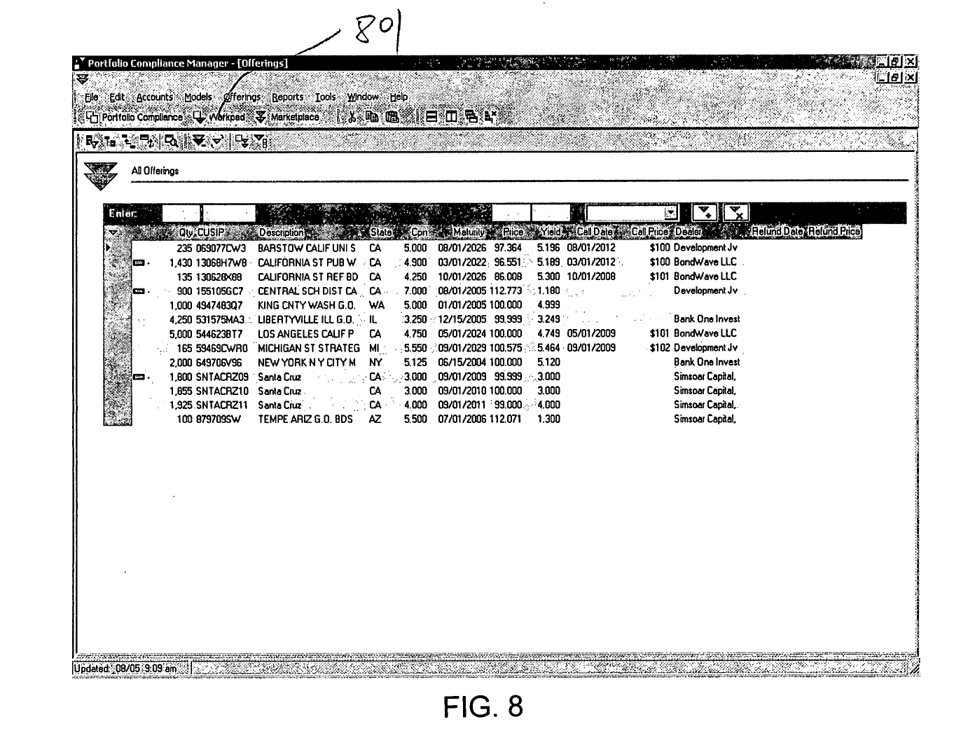

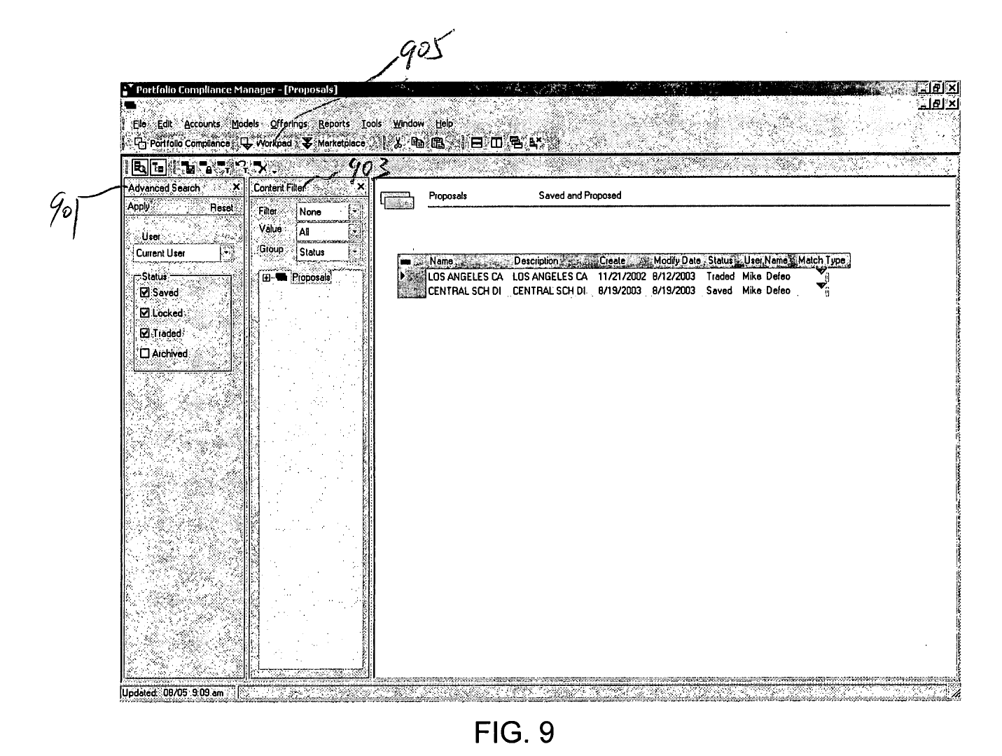

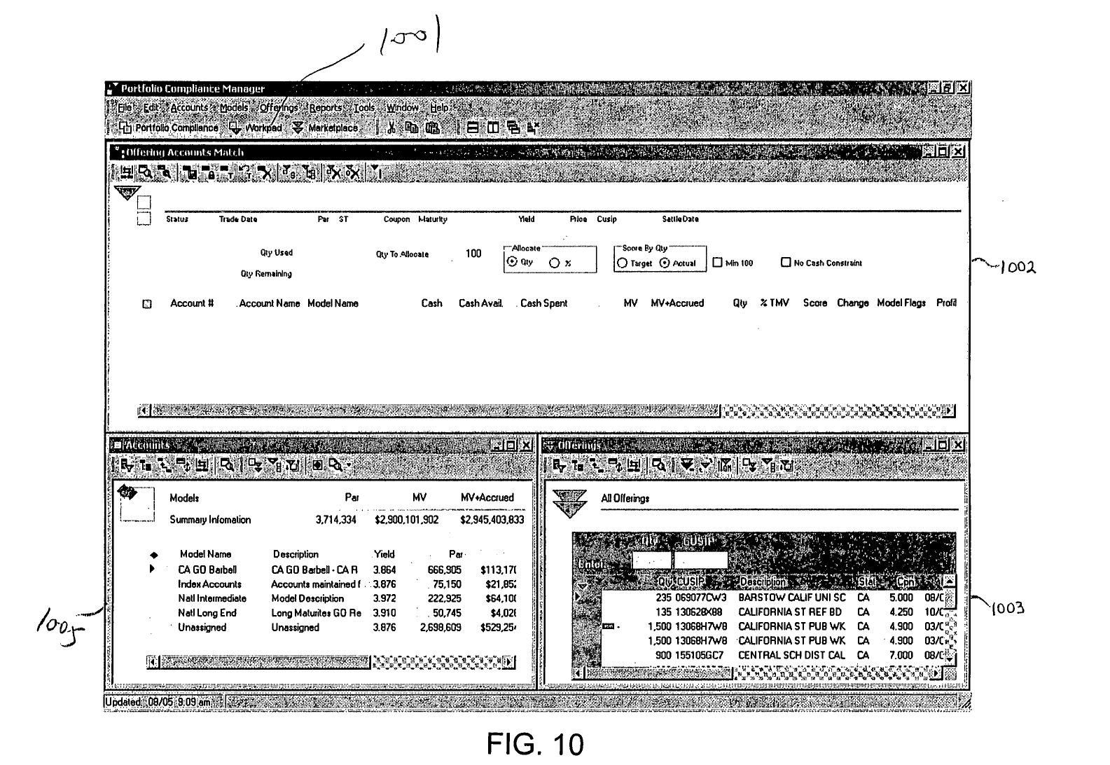

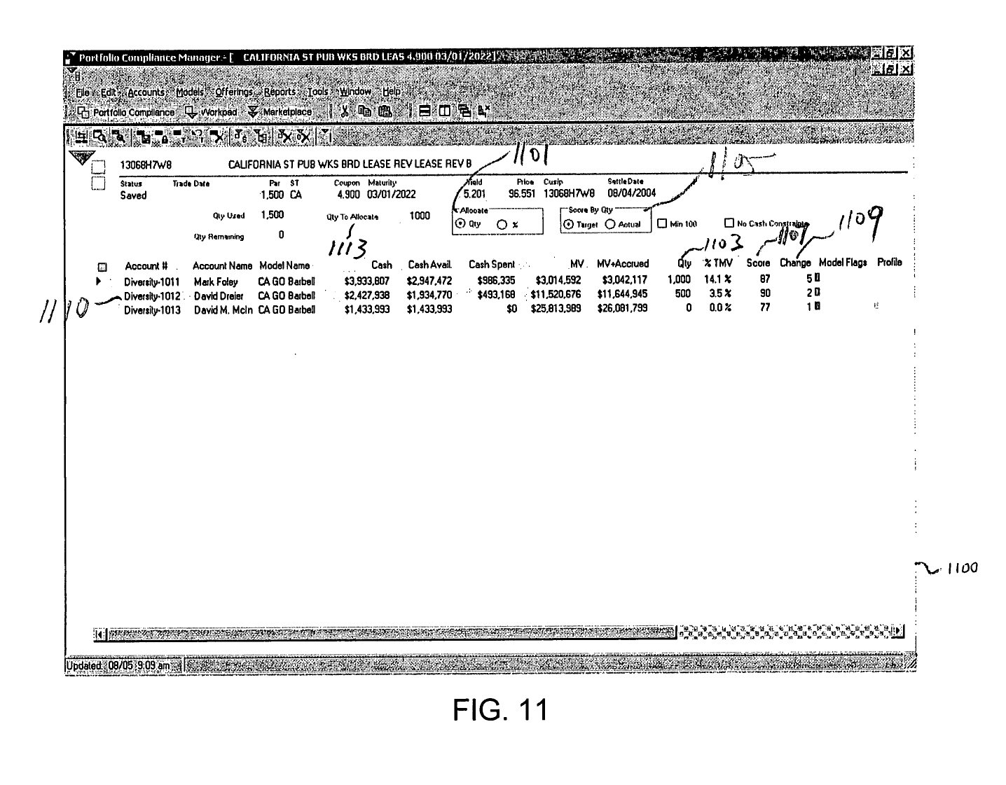

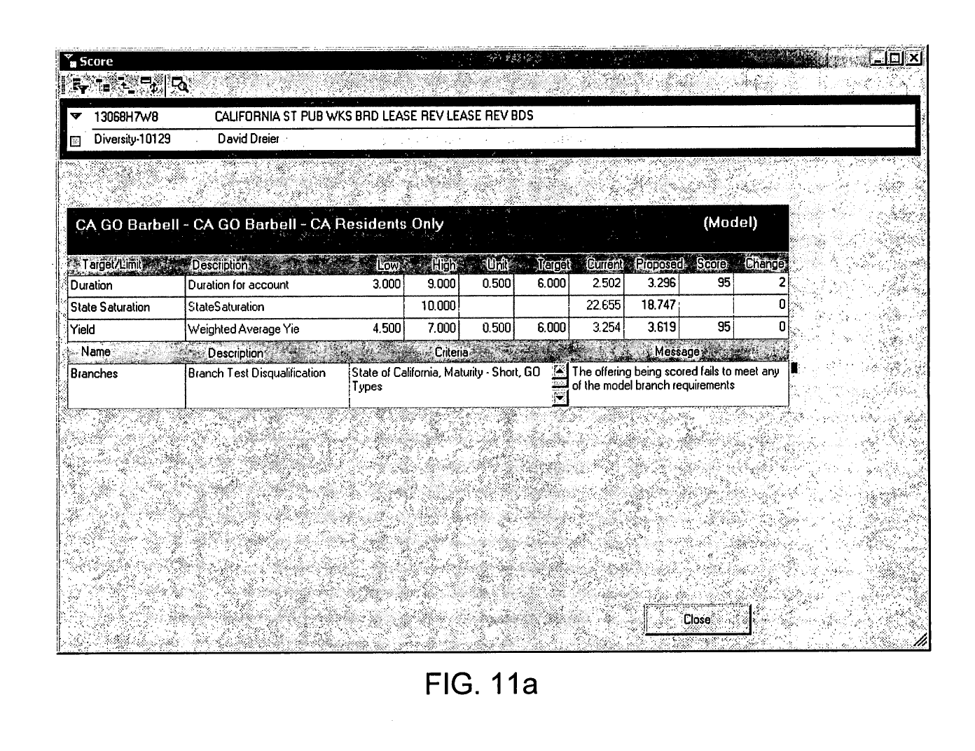

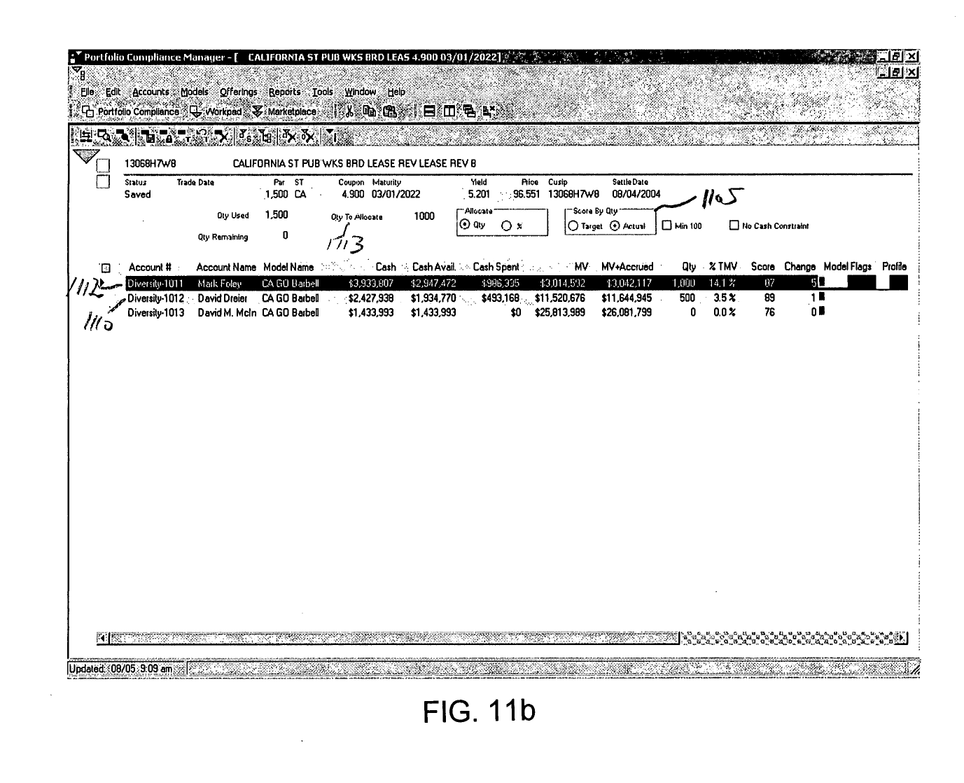

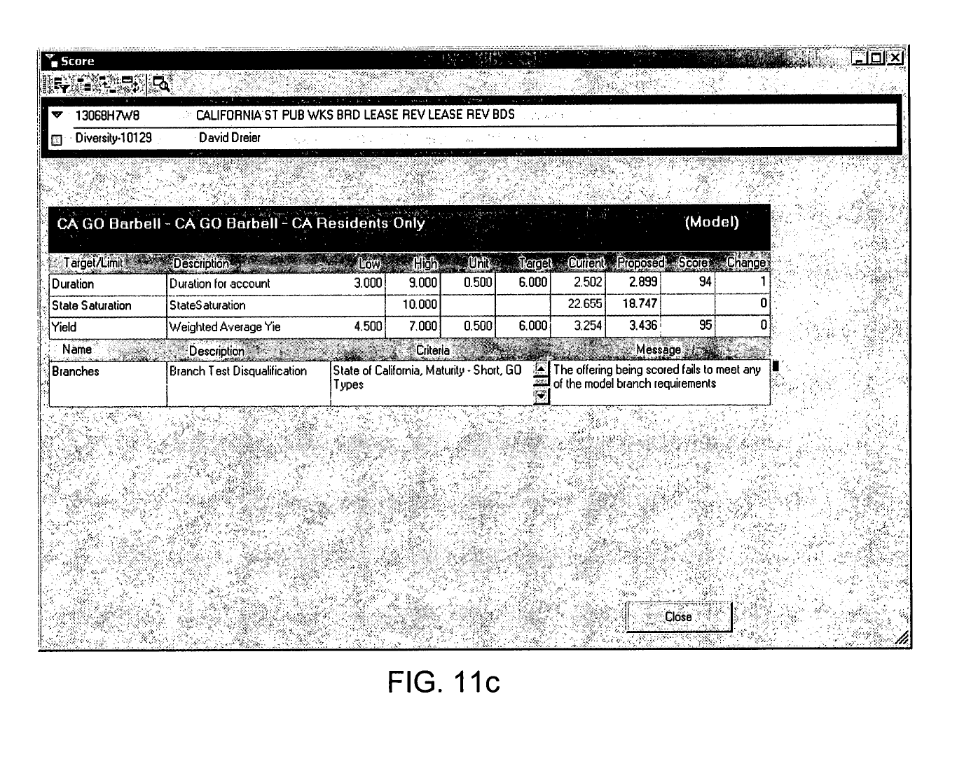

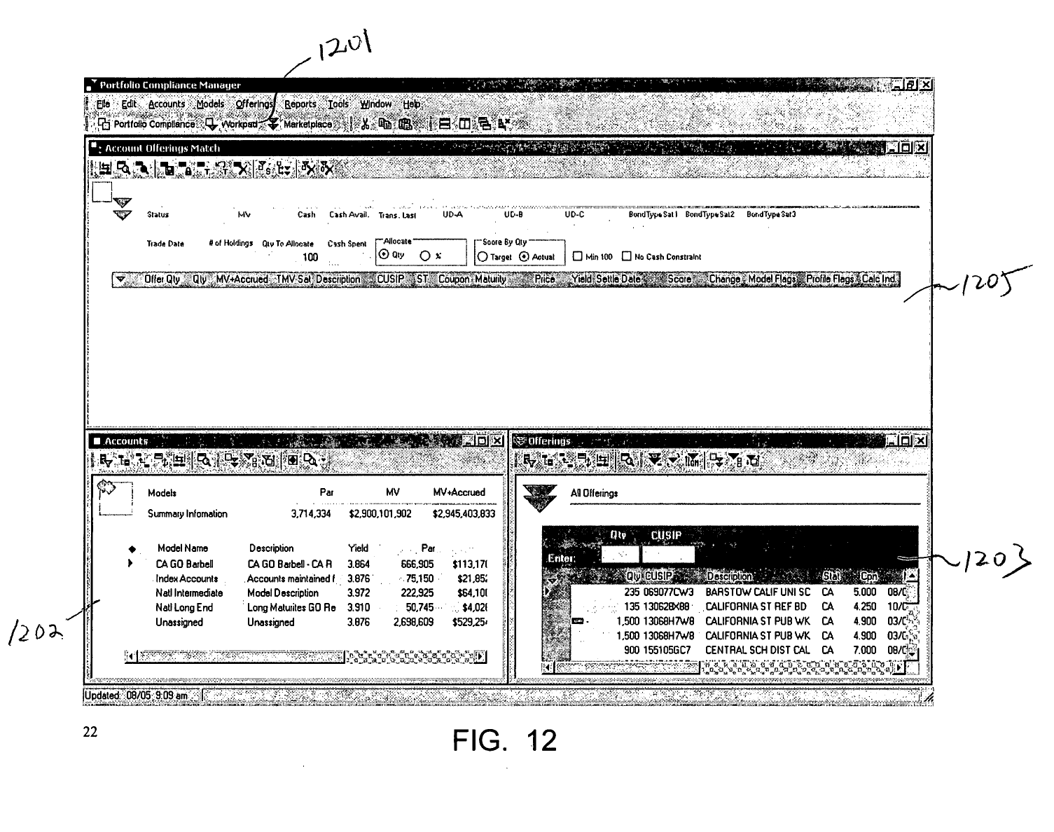

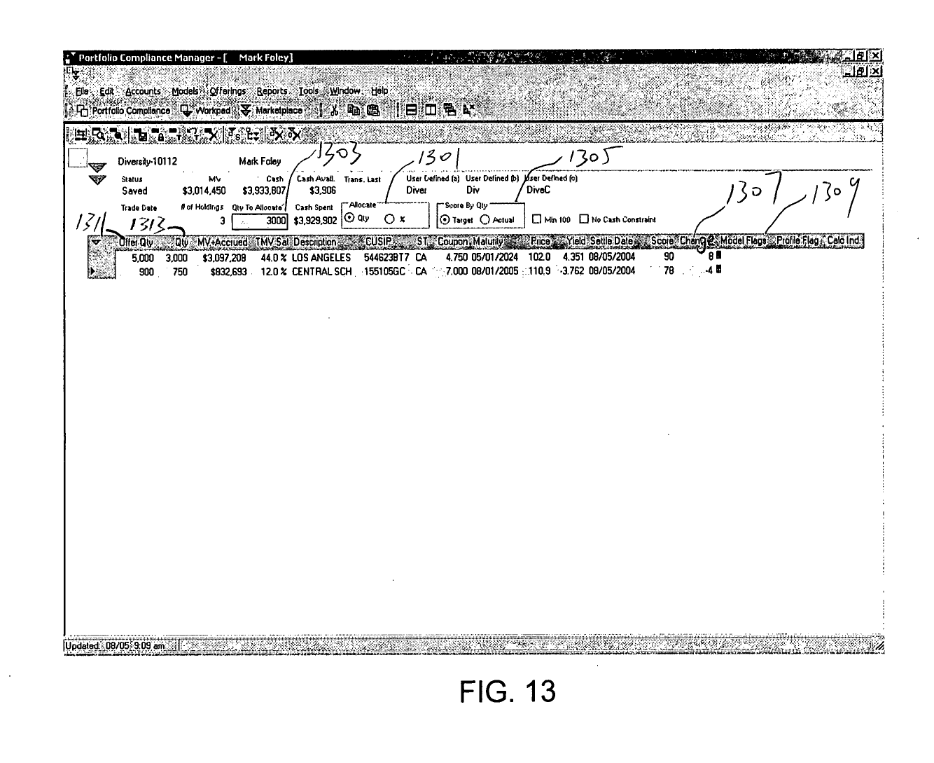

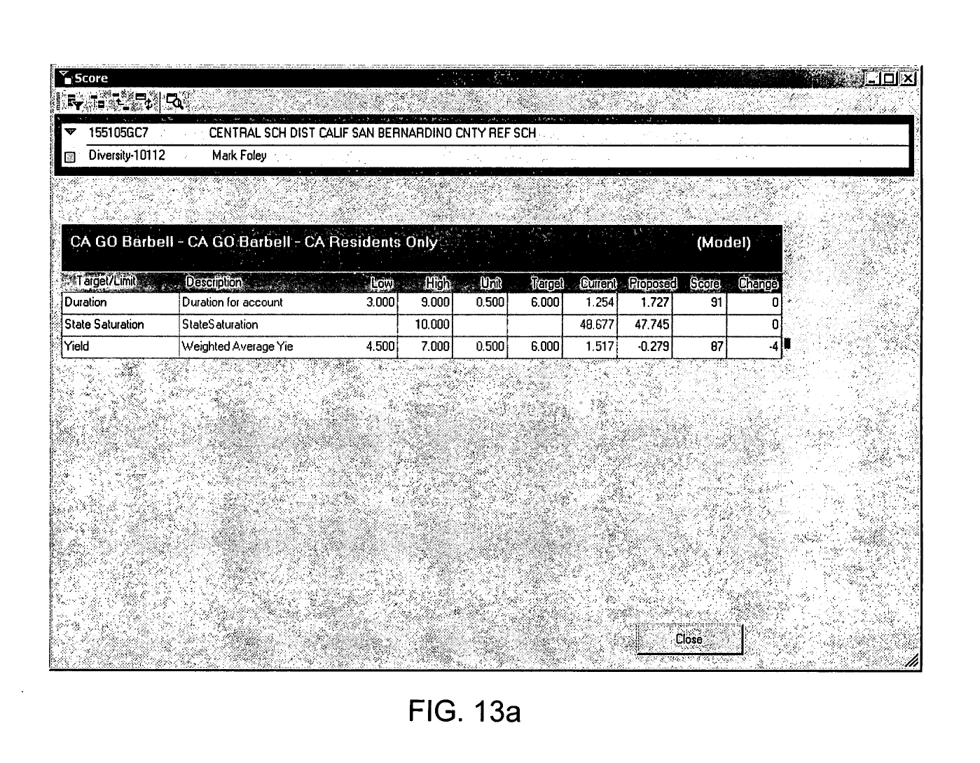

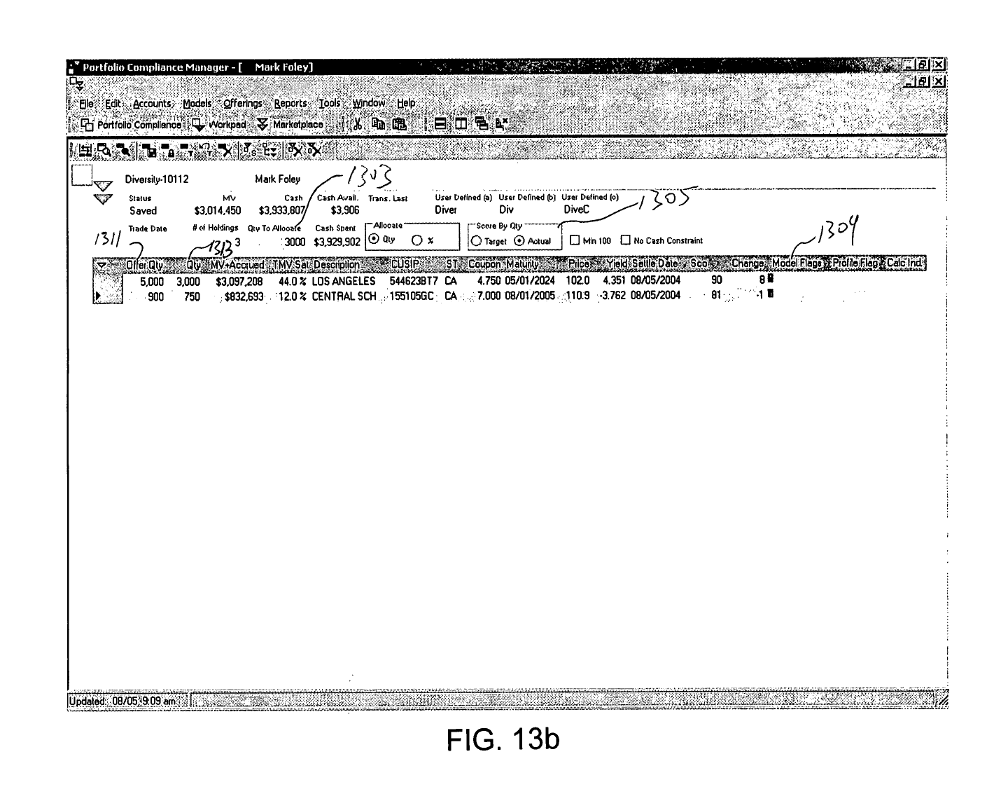

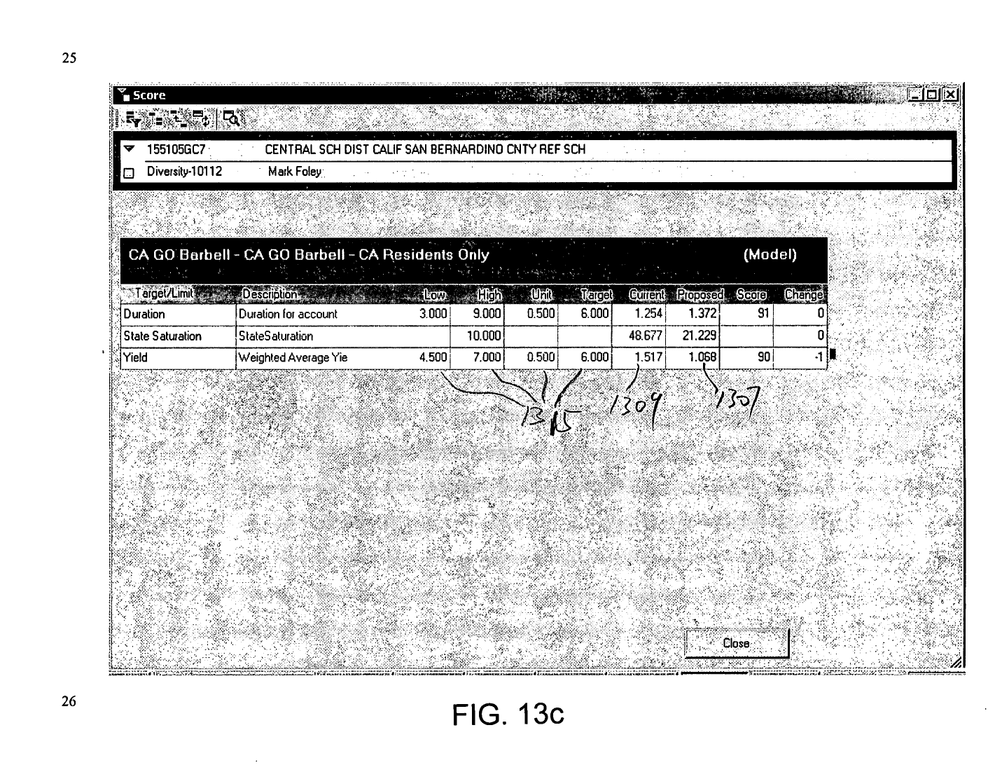

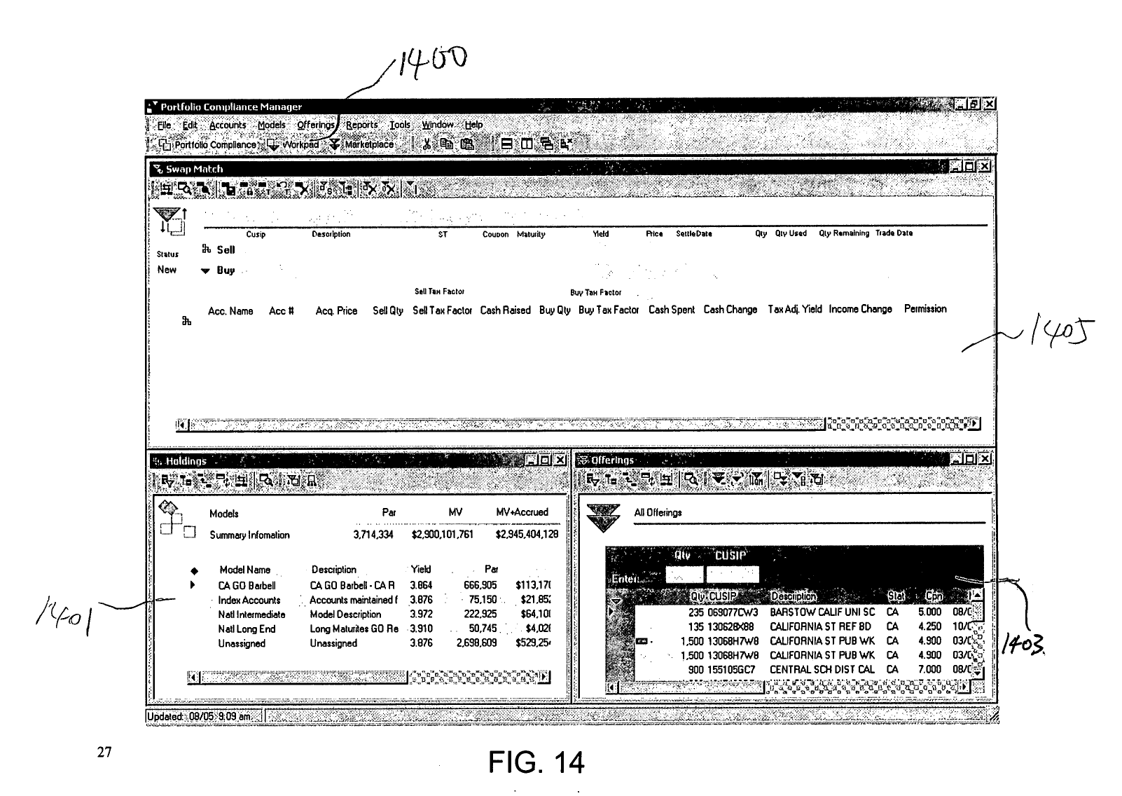

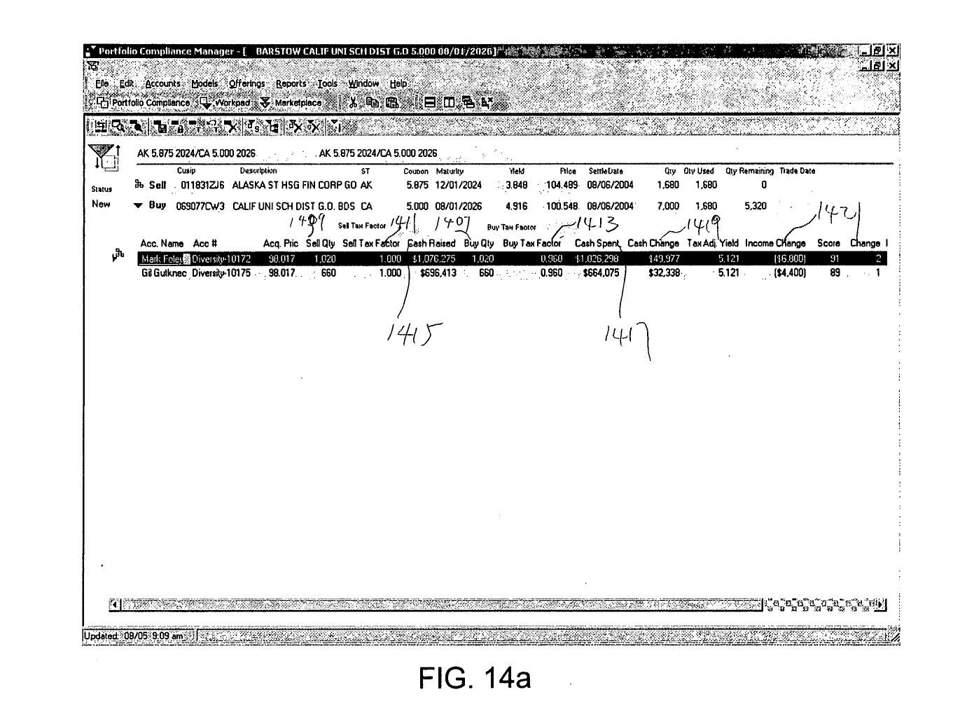

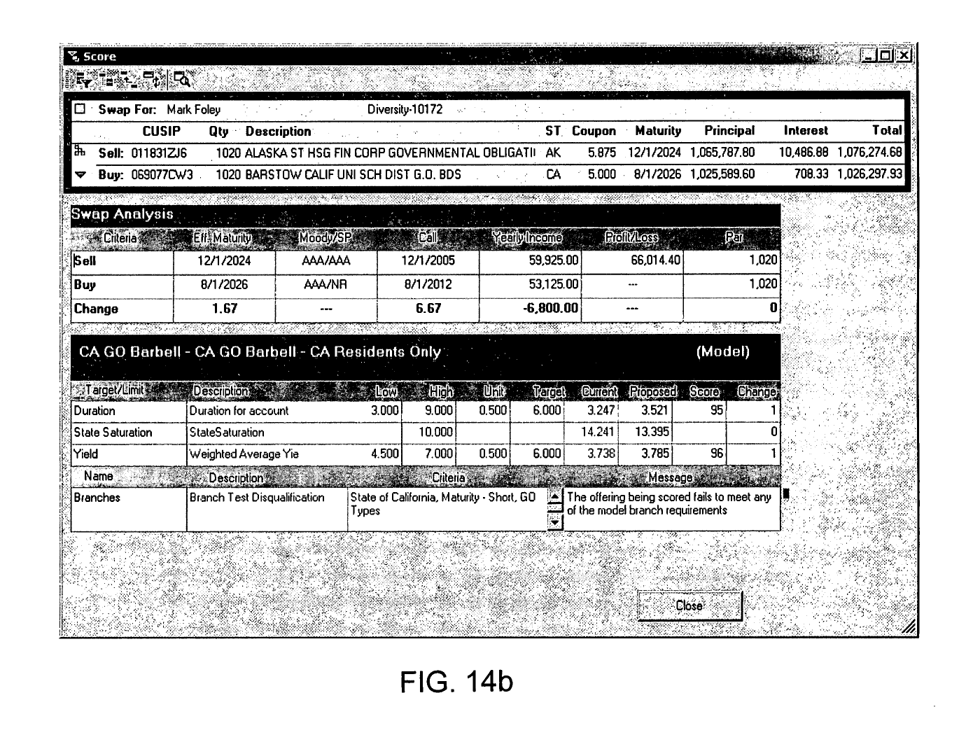

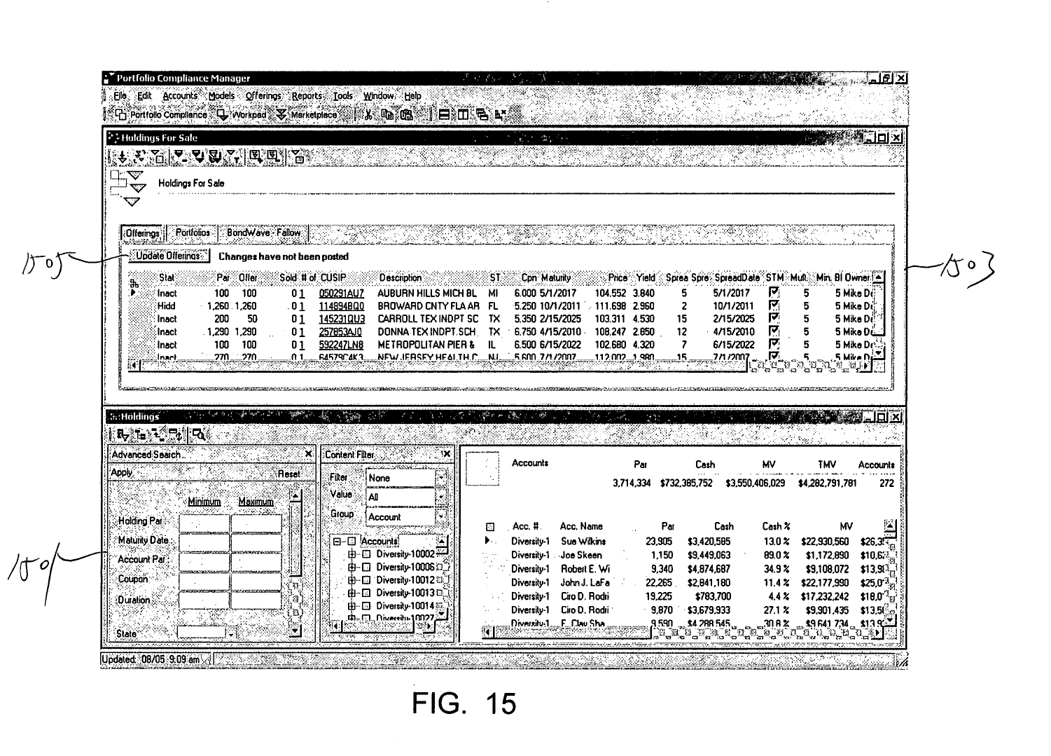

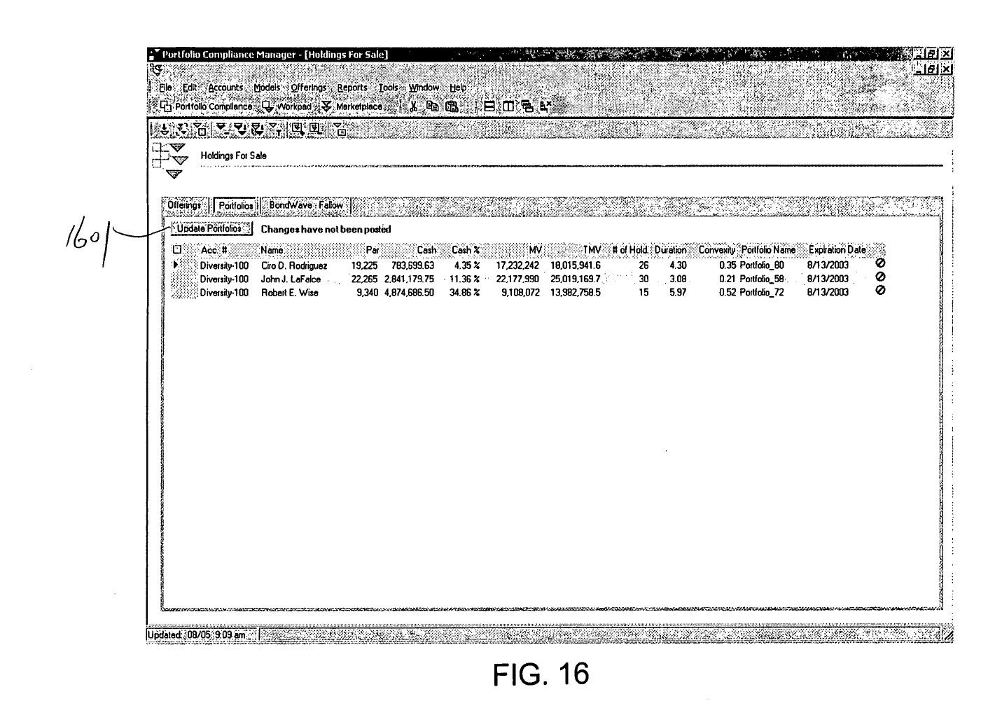

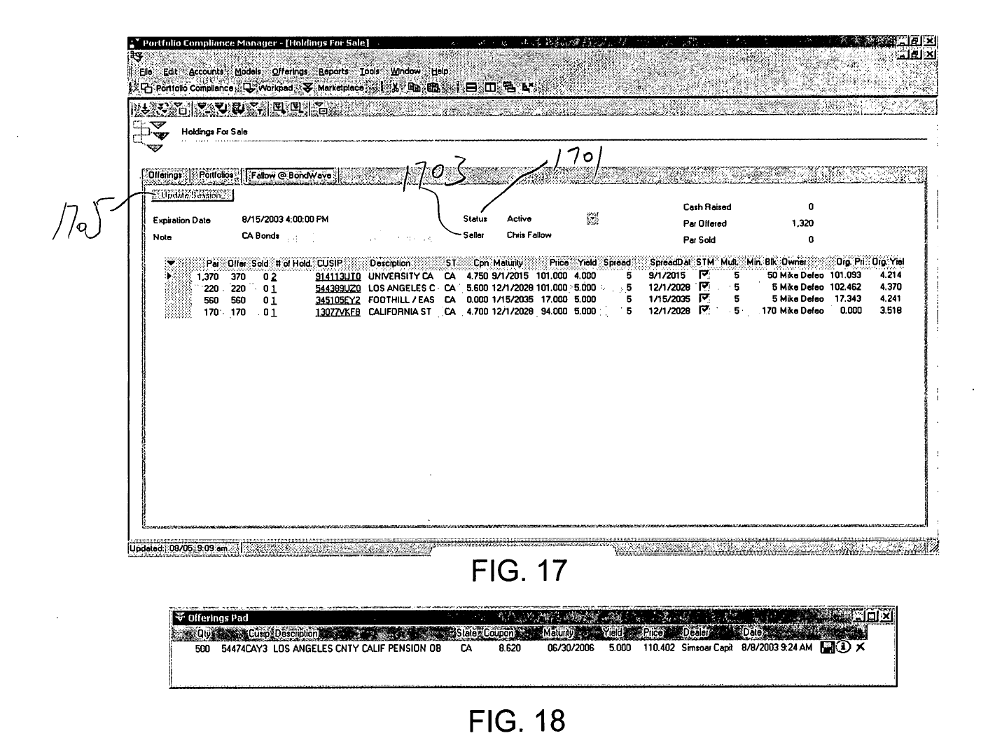

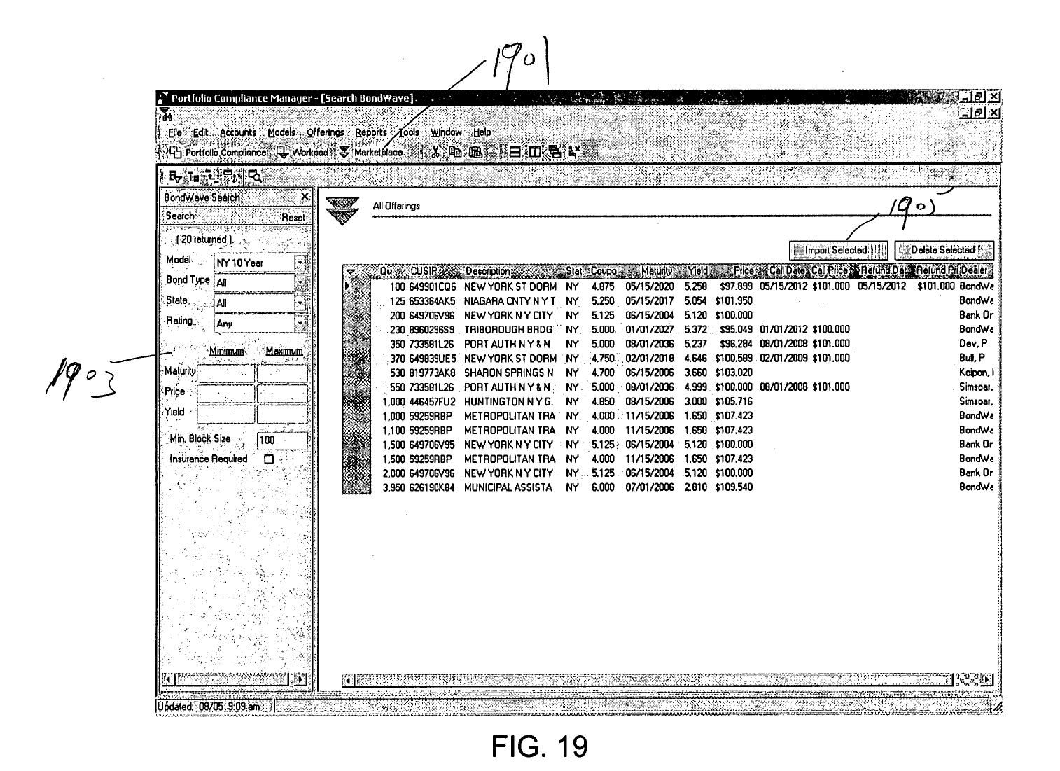

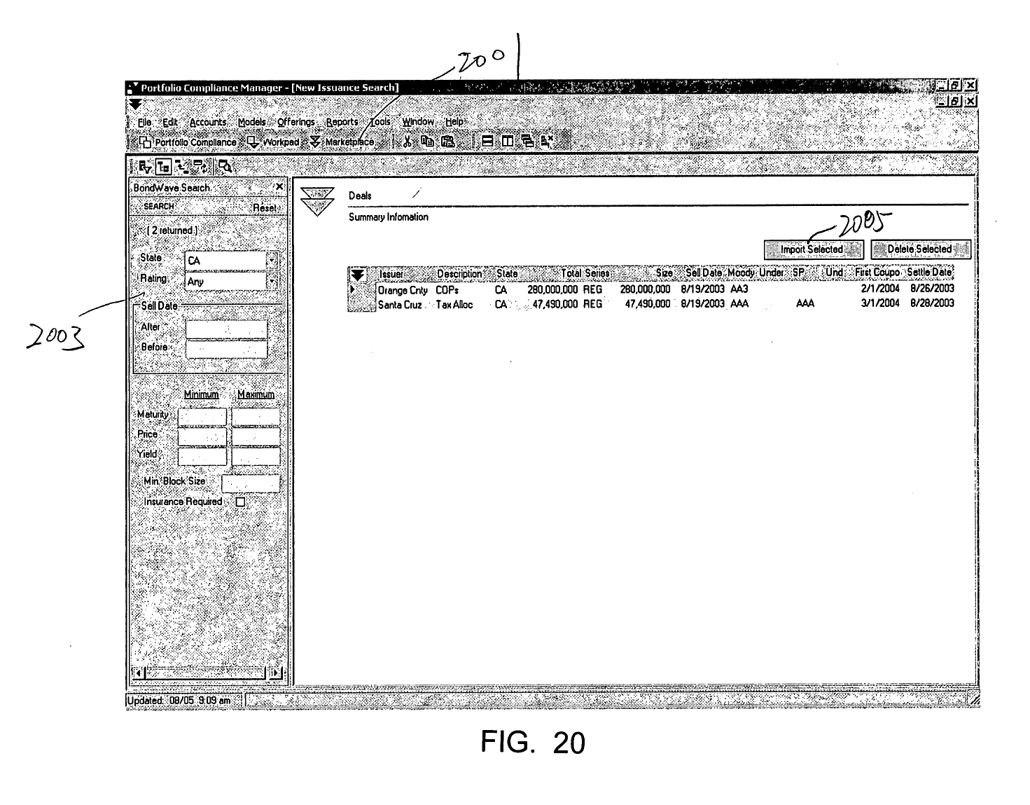

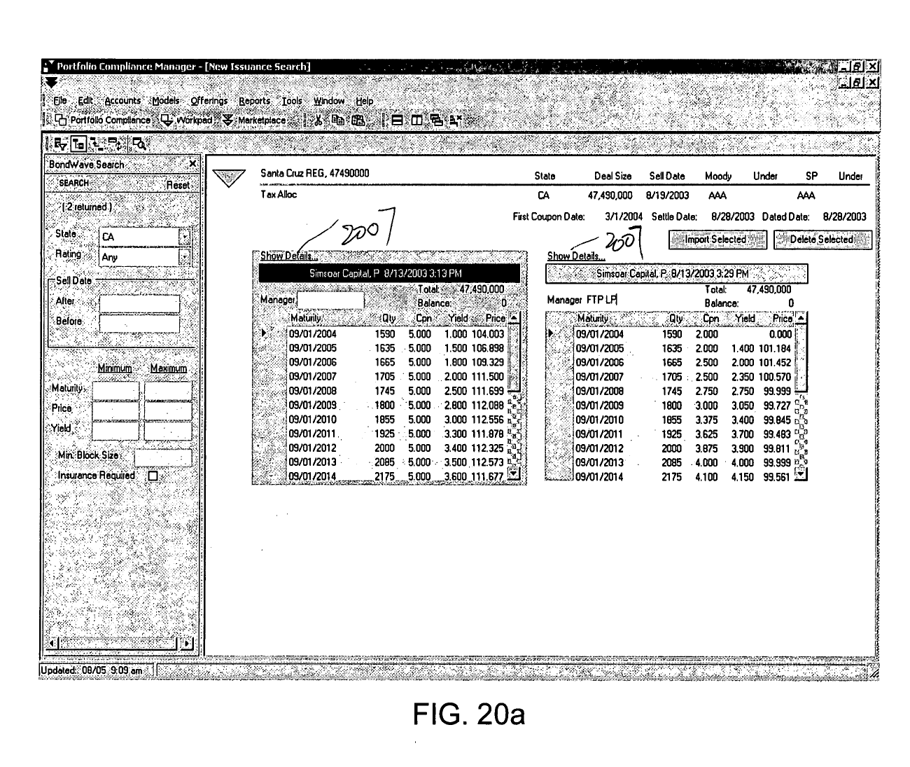

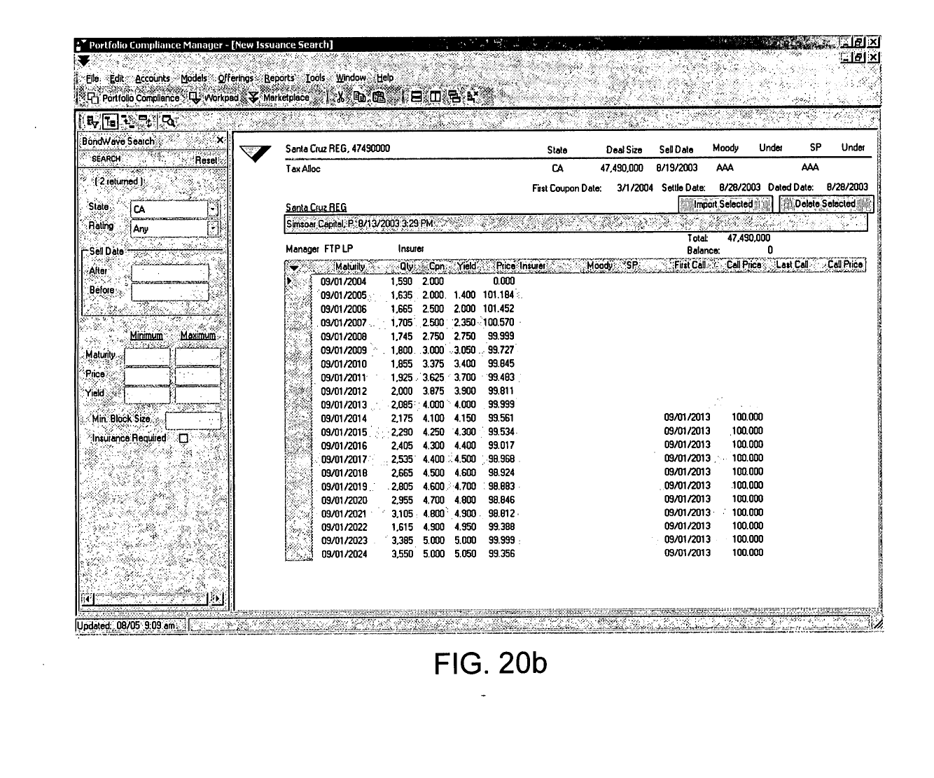

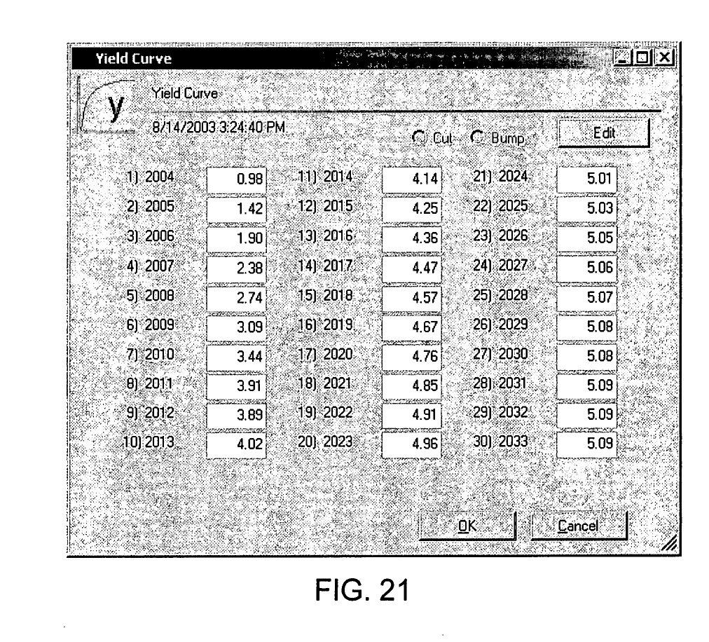

Referring to FIG. 2a, navigation within the exemplary compliance software application can be menu-driven, through the standard menu 20 (File, Edit, Accounts, Models, etc.), short-cut menu 25 (Portfolio Compliance, Workpad, Marketplace), and right-click menus (not shown). The user is able to “drill-down” into increasing levels of detail through, for example, a series of double-clicks on the selected data items.

I. Creating And Defining Models And Accounts

In accordance with one embodiment of the invention, a user can create with a computer one or more models defining investment strategies, which may include a plurality of first parameters defining fixed income security characteristics acceptable to investors (clients) represented by the user. In one example, models can serve at least two purposes: (1) models can define the investment strategy which guides the user, such as an investment manager as he manages his accounts' security allocations; (2) models enable the user to characterize the types and quantities of the securities he is looking for from the sell-side (his demand) or the securities he is willing to sell (his offerings).

FIG. 2a summarizes a series of models 201 created by the user to define the investment parameters for a group of accounts 205. In accordance with one embodiment of the present invention, the user can assign different models 201 to different accounts 205, which are investor security portfolios, and then group accounts 205 by the models 201 assigned to them.

Double-clicking a model 201 will “drill-down” to the accounts assigned to that model 201 as shown in FIGS. 2b-1 and 2b-2. Each account 205 consists of a set of descriptive fields which uniquely identify that account 205, including fields such as account number 213 and account name 215. Each account 205 is made up of a set of securities, referred to as holdings 217. Holdings are the securities contained in a portfolio. Holdings may be described by fields such as a unique identifier (e.g., a CUSIP number), quantity, description, current price, acquisition date, etc. Holdings data can be imported from the user's portfolio accounting system at the user's request, through an extract-transform-load (ETL) process that supports various source data formats.

FIG. 2c depicts an expanded view of the account/model screen. As it shows, preferably, holdings 217 can be searched or filtered using the interfaces, “advanced search” field 221 and/or “content filter” field 223.

Terms related to FIGS. 2a, 2b-1, 2b-2 and/or 2c are as follows:
Accounts: A number in this column indicates the total number of accounts (portfolios) that are assigned to a given model or a group of models.
Calc. Ind May indicate that there is a security held within the account for which the exemplary compliance software application cannot do a price/yield calculation. This security will be excluded from account statistics that depend upon security price/yield.
Cash: Indicates the total of cash balances held in an underlying account, or a plurality of accounts/portfolios assigned to a model or a group of models.
Cash %: Indicates the percentage of cash held in the portfolio.
Convexity: With respect to a change in interest rates, a measure of the rate of change in duration of a security, or the weighted average of the rates of change in durations for a plurality of securities held in an account. For fixed income securities, it is used in the estimation of price changes resulting from changes in interest rates.
Duration: A time weighted, present value weighted measure of a fixed-income security's cash flows, or the weighted average measure of those cash flows for a plurality of securities held in an account. Duration is used in the estimation of the price sensitivity of a fixed-income security or a plurality of fixed income securities for a given change in interest rates.
Holdings: A number in this column indicates the number of securities held in the portfolio.
Issuer: Indicates on a percentage basis, the most-held issuer within the portfolio identified by the issuer CUSIP. (The first 6 characters of a security CUSIP.)
MV (Market Value): Dollar amount equivalent to the principal amount of a security multiplied by the price of the security or the total dollar amount of a plurality of securities.
MV+Accrued (Market Value+Accrued Interest): The total MV of an account or a plurality of accounts plus any accrued interest for the securities held in the account or in the plurality of accounts.
OADuration (Option Adjusted Duration): Also known as effective duration. A duration measure adjusted for the embedded options (such as calls) in a security or for a plurality of securities held in an account. For non-callable bonds, modified duration and effective duration are equal.
Par (Par Amount): The principal amount of a security or the total principal amount of a plurality of securities due at maturity.
Sat %: (Issuer Saturation %) The percentage of the portfolio held in securities that were issued by the most-held issuer.
State: On a percentage of market value basis, the most-held state of issuance for securities within the portfolio.
Sat %: (State Saturation %) The percentage of the portfolio market value held in securities issued from issuers from the most-held state.
TMV (Total Market Value): Equal to the market value (MV) plus any cash held in an account or a plurality of accounts.
User Defined (a)/(b): Indicates user definable fields that can be imported into the exemplary compliance software application to be used for sorting or grouping of accounts.
Yield: Indicates the annual percentage rate of return earned on a security or weighted average annual percentage rate of return of a plurality of securities. Yield, when referred to a security, is a function of a security's price, coupon interest rate, and maturity.

Referring again to FIG. 2a, it shows that the exemplary compliance software can also summarize the aggregate cash balances (“Cash” 207) across all of the accounts 205 under each model 201. The total cash balance of each model or a portion of it can be designated as the demand of that model (“Demand” 209), and can be communicated back to the web-server 130 and/or other users in the electronic trading system 100 shown in FIG. 1, along with a description of the model branches and restrictions.

Preferably, the model data and past transaction data from all buy side users 101 of electronic trading system 100 (which can be generally referred to as “demand data”) can be transmitted to and aggregated at web-server 130 and distributed to all sell side users 105 in varying levels of detail. This aggregated demand data can be then used by the sell-side in their marketing and inventory management decisions, helping them to minimize their market risk and increase their potential trade opportunities. Efficiencies can be gained through the ability of the buy-side to automatically generate and distribute detailed descriptions of his aggregate demand to the sell-side. In addition to saving time, the combination of the demand requirements from individual accounts into larger blocks can facilitate the securities negotiation and buying process.

For each account, the user can set up an account profile in accordance with one embodiment of the present invention, as illustrated in the screen shown in FIG. 3. An account profile is a set of investment parameters set specifically for an account that augments the similar parameters of the account's associated model. With the exemplary compliance software application, the user can access this screen by right-clicking an account in FIG. 2b-1 or 2b-2 and selecting “Account Profile” from the menu. Similar to models, whose parameters include, but are not limited to, branches, restrictions, and portfolio target/limits that are described in greater detail below, an account profile, for example, may consist of restrictions 301 and portfolio targets/limits 303. However, in accordance with one embodiment of the present invention, branches preferably exist at the model level only. Account profiles add an additional level of account specific detail to the unacceptable security types and specific goals for accounts. When evaluating a proposed transaction as described below, the account profile will have effects on scoring and may produce an indicia, e.g., profile flags.

In the exemplary compliance software application, referring to FIG. 4, model parameters can consist of branches 401, restrictions 403, and portfolio targets/limits 405. Each of these can be based on, for example, bond types. When evaluating a proposed transaction, any violations to the parameters established in a model 411 will have effects on scoring and produce indicia, e.g., model flags, as described below.

Branches 401 may represent the acceptable parameters for the account holdings of accounts associated with the model 411 (“CA GO Barbell” model in this example). In accordance with one embodiment of the present invention, branches 401 preferably are viewed as “or” conditions. In the example shown in FIG. 4, the CA GO Barbell model 411 contains two branches, one for long maturity bonds and another for short maturity bonds. Securities that fit either branch are considered to fit the model.

Restrictions 403 may describe unacceptable characteristics for the account holdings of accounts associated with the model 411. In accordance with one embodiment of the present invention, restrictions preferably are viewed as “and” conditions. For example, the CA GO Barbell model 411 in FIG. 4 specifies that the user can not buy a bond with a coupon of less than 2% and also can not buy education purpose bonds.

Portfolio targets/limits (PTLs) 405 may specify the target, lower and upper limit for the specified bond type within a model 411. They can represent the user's portfolio management goal. In the example shown in FIG. 4, the CA GO Barbell model 411 specifies that the user is trying to achieve a target duration of 6, but values between 3 and 9 are acceptable.

Preferably, the user can also have the ability to limit the demand communicated back to web-server 130 and the other system users of the electronic trading system 100 through the drop-down “Demand Dissemination Limit” field 407 in FIG. 4.

A blank version of FIG. 4 can allow the user to add a new model. Along with adding branches, restrictions, and PTLs, the user can enter a primary name, secondary name and establish a demand dissemination limit for the new model. Entry screens used when adding branches, restrictions, and PTLs are described below.

The exemplary compliance software application, in accordance with one embodiment of the present invention, may generate a screen as that shown in FIG. 4a to enable the user to add a branch or restriction to a new or existing model. The screen shown in FIG. 4a can be accessible, for example, by right-clicking a model name in the data tree to the left in FIG. 2a or 4 and selecting the “Add New Branch” or “Add New Restriction” button (not shown) from the menu. The user can specify a branch or restriction name and description. The user can then build the branch's or restriction's criteria set by double-clicking an available bond type 410 from the list in order to include it in the criteria listed to the left, the branch or restriction bond types field 413. The user can also select a bond type and use the center arrow buttons to move the associated bond type in or out of the branch or set of restrictions. A similar screen can be utilized when editing an existing branch or restriction, and preferably, existing branches or restrictions may be deleted, for example, by right-clicking on an existing branch or restriction as shown in FIG. 4 and selecting “Delete” from the menu.

The exemplary compliance software application in accordance with one embodiment of the present invention, may generate a screen as that shown in FIG. 4b to enable the user to add or edit a PTL for a new or existing model. The user can specify a PTL name and description, and establishes the target, target type, limit high, limit low, unit, and unit type for a given bond type. A similar screen can be utilized when editing or deleting an existing PTL.

Model limits describe the acceptable bounds for a measured characteristic of an account associated with the model. Preferably, the compliance software application in accordance with one embodiment of the present invention can provide indications for cases where accounts exceed these bounds.

Model targets describe the preferred value of a measured characteristic of an account associated with the model. Preferably, the compliance software application in accordance with one embodiment of the present invention can provide information on the degree of an account's compliance with these targets in the form of a score, for example.

The value assigned to the unit for a portfolio target can determine the degree that a score is affected by a difference between the preferred value or “target” and the actual measure of an account characteristic.

In order to compute the numerical score, which in this example is a composite measure based on multiple targets, the difference between each target and each actual value for an account can be calculated, these differences weighted based on the individual unit measures assigned to the target for the model, and the effect on the score can be determined based on the PTL target type.

For example, an account with duration of 5.0 associated with a model with duration target of 6.0 and duration unit of 0.5 will be scored to reflect its being different from the target by two units (6.0−5.0=1.0; 1.0/0.5=2). An Account with yield of 4.0 associated with a model with yield target of 5.5 and yield unit of 0.25 will be scored to reflect its being different from the target by six units (5.5−4.0=1.5; 1.5/0.25=6).

In accordance with one embodiment of the present invention, different PTL target types can be based on how the unit differences between target values and actual values of account characteristics are used to calculate scores and to set warning condition model flags. If an account's value for a characteristic is less than the target, for example, it can add to the score, detract from the score, raise a warning condition model flag, or can be ignored, based on the PTL target type. Similarly, but independently, if an account's value for a characteristic is greater than the target, it can add to the score, detract from the score, raise a warning condition model flag, or be ignored. Various combinations of these possible effects for being above or below the target give rise to the eight different PTL target types supported in the exemplary compliance software application.

In this example, the eight PTL target types and their visual representations that can be selected for a PTL are shown in FIG. 4c and their impact on scoring and model flags are as follows:
Peak Negative impact for values below the target Negative impact for values above the target
Incline Negative impact for values below the target Positive impact for values above the target
Ramp Up Negative impact for values below the target No impact for values above the target
Valley Positive impact for values below the target Positive impact for values above the target
Decline Positive impact for values below the target Negative impact for values above the target
Ramp Down No impact for values below the target Negative impact for values above the target
High Limit No impact for values below the target Warning condition Model Flag for values above the target
Low Limit Warning condition Model Flag for values below the target No impact for values above the target

Preferably, in accordance with one embodiment of the present invention, using (1) model targets and limits established as part of the definition of a portfolio's associated model, (2) calculated portfolio attribute values for attributes associated with the associated model's targets and limits, (3) a method of weighting differences between the target values and the portfolio values of the calculated attributes as may be defined by the portfolio's associated model, and (4) a PTL target type that may be established for each of the associated model's targets and limits, a computation of a portfolio score may be performed. By way of example, a portfolio with duration of 5.0, yield of 4.0, and issuer saturation of 6.0% associated with a model with a PTL for a target duration of 6.0 and PTL unit of 0.5 of type “Peak”, a PTL for a target yield of 5.5 and PTL unit of 0.25 of type “Ramp up”, and a PTL for a issuer saturation limit of 5.0% could have a portfolio score computed as follows.

An initial “base-line” score of 100 could be established.

The portfolio's duration of 5.0 is below the duration PTL target of 6.0 by 1.0, which is two times the duration PTL's unit of 0.5. Because the PTL target type is “Peak”, there is a negative impact to the score of magnitude 2.0 because the portfolio measure is below the target.

The portfolio's yield of 4.0 is below the yield PTL target of 5.5 by 1.5, which is six times the yield PTL's unit of 0.25. Because the PTL target type is “Ramp up”, there is a negative impact to the score of magnitude 6.0 because the portfolio measure is below the target.

The portfolio issuer saturation of 6.0% is greater than the PTL limit of 5.0%, resulting in a model flag being set.

As a result, a portfolio score could be computed as 100 minus 2 minus 6, for a net score of 92. This score and an indication, by means of a compliance model flag showing that the portfolio issuer saturation limit has been exceeded, could be displayed in windows and reports displaying portfolio compliance information.

Optionally, all users of a compliance software application in accordance with an embodiment of the present invention at a firm share the same set of model targets. However, users can use “model overrides” to customize the way scoring results are computed for themselves, without changing the way scores are computed for other users. For example, using the model overrides interface as shown in FIG. 5, a user can specify a percentage increase or decrease of the weightings of score contributions for each of a model's portfolio targets. For example, a user could choose to reduce the score contribution for a portfolio target based on duration and increase the score contribution based on yield.

As stated above, in the exemplary compliance software application, model parameters can be based on bond types, which can be the building blocks for portfolio models. Bond types may be created by the user to establish clearly defined categories of securities based on security characteristics. By specifying one or more security characteristic values or ranges, a bond type definition can be basic or complex. By way of example, a bond type of “Federally Tax Exempt” might be defined based on a single security characteristic, federal tax treatment. By way of further example, a bond type of “New York Revenue Non-call” might be defined based on multiple security characteristics such as state of issuance, the source of funds to pay the debt service, and whether or not the bond has any call provisions. Bond types such as these can be used separately or in combination to establish portfolio model branches, restrictions, and PTLs, as well as account profile restrictions and PTLs.

Bond description data for all holdings and offerings for example, can be provided through a third party data vendor. Through an ETL process, bond description data can be downloaded, for example, from the service provider's website 135 of FIG. 1a as needed. In accordance with one embodiment of the present invention, the website 135 of FIG. 1a can supply a set of some standard bond types as shown in FIG. 6, but the user can also specify his own set.

In accordance with one embodiment of the present invention, accounts are made up of individual securities called holdings. Referring to FIG. 7, the exemplary compliance software application allows the user to search holdings across all accounts. The screen shown in FIG. 7 enables the user to search holdings that have like characteristics by inputting values in the advanced search field 701 and/or content filter field (not shown, but can be similar to that in FIG. 2c) and viewing the results in window 703. The example in FIG. 7 shows a list of 237 accounts that contain one or more holdings that have a duration between 2 and 4. The user can then view the holdings for an account by double-clicking on it, for example.

A distinguishing feature of the search functionality within a compliance software application of the present invention is the ability to search by bond type. An example would be a user-defined bond type that is defined as Coupon 0.0-2.65. If this bond type is used in a search, the search would return accounts that contain holdings which have coupons between 0.0 and 2.65. Searching by bond types functionality can also incorporated in other areas in the application, such as searching for offerings.

In addition to being able to search for portfolio holdings based on their characteristics, and identifying accounts associated with those holdings, searches based on portfolio criteria can also be performed. For example, searches may be based on portfolio characteristics such as state-of-record, or a user-defined portfolio related field. Furthermore, searches may be based on aggregate measures of portfolios holdings, such as weighted average yield or state saturation percentage.

Using the exemplary compliance software application, the user can run different account reports and benchmark analyses. Some of the reports that can be produced by the application are as follows:
a. Account Comparison Report: Allows the user to compare the portfolio statistics between two accounts.
b. Account Benchmark Report: Compares the statistics within a selected account to the statistics in a selected benchmark.
c. Compliance Report: This report identifies areas where a selected account is outside of the PTL defined by the model associated with the account.
d. Compliance Status Report: This report indicates how the selected account compares to the restrictions and PTL defined by the model associated with the account.
e. Compliance Status Details: In addition to the information provided in the compliance status report, this report details the holdings that violate the model restrictions.

Used in this specification, a benchmark is a point of reference from which comparison measurements may be made, and serves as the standard by which an account is measured within a compliance software application. Similar to an equity index like the DJIA (Dow Jones Industrial Average), benchmarks are hypothetical baskets of real securities. Benchmarks like these are commonly used as marketing tools when describing investment performance. Benchmark statistics can include, for example, categories such as; purpose type, state, coupon, and purpose class.

In accordance with one embodiment of the present invention, the user can assign benchmarks to accounts and produce various reports that compare accounts to a given benchmark. The user can choose to generate reports comparing the account to the assigned benchmark or another benchmark from the list. The user can also create a model that emulates the characteristics of a benchmark.

II. Analyzing Offerings And Creating Proposals

The exemplary compliance software application allows the user to run different scenario analyses and create proposals for the user's accounts for securities offered for sale in the market, and/or for holdings to be offered for sale out of the user's accounts. In accordance with one embodiment of the present invention, the analysis can be done by correlating the model parameters and/or account profiles with the fixed income securities offered for sale in the market, and/or holdings in the user's accounts to be offered for sale to the market.

1. Offerings

Before doing an analysis, the exemplary compliance software application can enable the user to collect offerings made in the market from the sell-side. An offering is a seller's indication of the terms under which he is willing to sell a security. Offering information can include, but are not limited to a CUSIP number, brief description, par amount, quantity restrictions (multiples of, minimum block size), settle date, offering dollar price, and a link to a detailed security description. The exemplary compliance software application of the present invention can generate the offerings screen as that represented in FIG. 8. The offerings screen is a “scratch pad” on which the user can collect offerings made available to him from the sell-side. FIG. 8, for example, can be accessible by selecting “Offering” from the “Workpad” menu 801.

Offerings may originate from these three sources, for example:
A. Users can import offerings posted on the service provider's web-server 130 of FIG. 1a by the sell-side.
B. Users can import directed offerings sent via the service provider's web-server 130 of FIG. 1a from the sell-side.
C. Users can manually enter an offering description for offerings received outside the electronic trading system 100 of FIG. 1a (via phone, fax, etc.)
   Given an offering, the user can run a series of scenarios, matching the offering(s) to the demand from account(s), thereby creating a proposal.

One kind of offerings is new issuance, which is the initial offering of securities issued by institutions such as municipalities or corporations for funding ongoing operations or specific projects. Each new issuance within the exemplary compliance software application may include a deal and its corresponding scales.

A deal in the exemplary compliance software application is the header information corresponding to the initial offering from the bond issuer. A deal can include a description of the new issue, including the name of the issuer, purpose, total quantity, ratings, first coupon date, sale date, sale time, and first settlement date.

A scale in the exemplary compliance software application can define the structure of a deal, detailing the individual securities that comprise it. A scale can comprise a quantity, coupon, yield and price for each maturity or security. In the competitive new issue market, multiple broker/dealers submit bids to the issuer for a deal. Prior to the deal's sale or award, broker/dealers distribute their scales to buyers, gathering indications of interest. Broker/dealers submitting bids that produce the lowest interest cost to the issuer will be awarded the deal. These broker/dealers are then authorized to offer the securities in the market at their stated scale levels. The users can import the most up-to-date scale information posted on, for example, the service provider's website 135 of FIG. 1a, or manually enter a scale or a deal received from outside the electronic trading system 100 of FIG. 1a (via phone, fax, etc).

During the pre-sale scale evaluation period, the user can convert a maturity or groups of maturities into offerings. In this example, once these scale items or maturities have been converted, they can appear on the offerings screen described in FIG. 8. From there, the user can run offering match proposals and other scenario analyses to help finalize his needs. After he is satisfied with the results, the user can save the proposed transaction(s) and submit orders for the offerings or scale items. After the deal has been awarded, the user can be notified by the winning sell-side bidder of the scale items and amounts he will be allocated.

2. Proposals

Proposals in accordance with one embodiment of the present invention can originate from one of the following scenarios: an “offering match,” an “account match,” or a “swap match.” FIG. 9 is a depiction of a proposal screen produced by the exemplary compliance software application. This screen summarizes the proposals that have been created by the user. Preferably, double-clicking a proposal will display its details, which may include the offerings, holdings, or accounts matched, quantities allocated, scores, and any model or account profile flags. Advanced Search field 901 or Content Filters field 903 is accessible through the interfaces on the left. In the exemplary compliance software application, the user can access this screen by choosing “Proposals” from the “Workpad” menu 905.

In accordance with one embodiment of the present invention, proposals in the exemplary compliance software application can have, for example, one of the following four statuses—“New,” “Saved,” “Locked” and “Transacted.” These statuses define the stage of evaluation for a potential buy and/or sell. In a single user environment, proposal statuses enable the user to quickly organize multiple scenarios that are being considered. In a multi-user environment, proposal statuses provide the user greater organization, and also communicate what proposals are being considered for an account to other users.

A status such as “new proposals” or the like can indicate that the user has initiated a proposal. Within the exemplary compliance software application, it shows that the user has not saved any work he has done to create a proposal or match scenario. Preferably, to other users in a multi-user environment, there will be no visible change to the cash balance or account holdings for the account in the scenario.

A status such as “saved proposals” or the like can be used during the proposal evaluation phase. Within the exemplary compliance software application, it shows that the user has created a proposal or match scenario and saved the result for continued analysis. Preferably, to other users in a multi-user environment, there will be no visible change to the cash balance or account holdings for the account in the scenario.

A status such as “locked proposals” or the like can indicate a more certain outcome. Within the exemplary compliance software application, it shows that the user has done some work to create a proposal or match scenario and approves the results, but has yet to receive confirmation or allocation of the bonds from the sell-side making the offering. Preferably, to other users in a multi-user environment, this offering will appear as a holding, reducing the cash balance, and reducing the risk of over-buying for the given account.

A status such as “transacted proposals” shows the most certain outcome, representing a completed transaction between the user and the seller. Within the exemplary compliance software application, a transacted proposal will credit or debit the cash balance of the accounts affected, and add or remove the offering as an account holding(s). Preferably, information from a transacted proposal can be printed in a report to produce trade tickets, or exported to a back-office system.

Optionally but preferably, a software application of the present invention supports the ability to automatically generate and send e-mail messages that describe the impact that would result from the transacting of a proposal to e-mail addresses associated with each of the accounts involved in the proposal. Preferably, the e-mails so generated would be based on a set of e-mail templates appropriate to each of the various proposal types.

3. Offering Match

Using the exemplary compliance software application, in the offering match scenario, the user can match an offering to one or more accounts. By selecting the “Offering Match” option from the “Workpad” menu 1001, the user can launch the screen containing three windows as depicted in FIG. 10. The offering accounts match window 1002 is where securities from a selected offering are allocated to accounts, and the results displayed. To start a proposal, the user can select and drag an offering from the offerings window 1003 and accounts from the accounts window 1005 onto the offering accounts match window 1002. The accounts window 1005 initially displays the highest-level view of the account, a summary of all accounts grouped by model. Clicking on a model group allows the user to “drill-down” to the more detailed accounts level, where account searches may be performed using the advanced search and content filter mechanisms described earlier in this specification. Once the selected offering and account(s) have been dropped onto the offering accounts match window 1002, the user will be able to enter proposal parameters and options in order to evaluate the resulting allocations' impact on the accounts.

Referring to FIG. 11, in the offering account match window 1100, the user has matched an offering to three accounts. By selecting the corresponding option from the “Allocate” box 1101, the user can allocate offerings either by a specified quantity, or by a quantity calculated for each account based on a specified percentage of total market value of securities held in each account. The offering can be allocated to the accounts in the order from top to bottom that they appear on the screen. Different allocations of the offering can be produced by re-sorting the accounts based on any of their associated columns. The allocation quantities for the offering can also be manually controlled by entering values in the quantity (Qty) 1103 field corresponding to each account.

Preferably, when considering an offering, the user may run multiple iterations of a scenario in an effort to identify which account(s) will be most positively impacted by the allocation of the offering. Still referring to FIG. 11, based on the option the user has selected from the “Score by Qty” box 1105, each allocation iteration will produce a score 1107 corresponding to each account. The difference between the account score after allocation, as compared with the account score prior to allocation, is measured and shown in the change column 1109. When scoring by target, as depicted in FIG. 11, the score 1107 and the score change 1109 are based on the target allocation quantity shown in “Qty to Allocate” field 1113 for each account regardless of whether there would be sufficient securities left over from prior allocations. This allows the impact of the target allocations for each account to be measured regardless of its order of appearance in the list, or the quantity of securities offered. In this example, a target allocation quantity of 1,000 will be allocated to each of the three accounts even though only a quantity of 1,500 has been offered. After allocating the offering in this scenario, the user might choose to re-sort the accounts by the change column prior to reallocating, which would bring the most positively impacted accounts to the top of the list.

In this example, the “David Dreier” account 1110 has a change in score of 2, bringing the total score to 90. This account has the second most positive impact from the target quantity of 1,000. The scoring by target detail for the “David Dreier” account is shown in FIG. 11a. Notice that the entire change results from the offering allocation bringing the account closer to its PTL of 6 for its duration target, as defined by the account's associated model.

After scoring by target and determining the most appropriate accounts to receive allocations of the offering, the user can confirm that the proposal is still suitable in light of actual allocation quantities. When scoring by “actual,” as depicted in FIG. 11b, the user will allocate indicated quantities of the offering, subject to the cash available in each account, until the quantity offered has been exhausted or all target allocations have been satisfied. In this example, only the “Mark Foley” account 1112 will receive the specified 1,000 quantity. The “David Dreier” account 1110 will now receive the actual quantity balance of 500 bonds. The reduced actual allocation to the “David Dreier” account 1110 will have a less positive impact on the score as compared with the previous results of the scoring by target. Details of the results of scoring by actual are shown in FIG. 11c.

4. Account Match

In the account match scenario, the user can use the exemplary compliance software application to match an account to one or more offerings. By selecting the “Account Match” option from the “Workpad” menu 1201, the user launches the screen containing three windows depicted in FIG. 12. To start a proposal, the user can select and drag an account from the accounts window 1202 and offering(s) from the offerings window 1203 to the account offering match window 1205. The accounts window 1202 initially displays the highest-level view of the account, a summary of all accounts grouped by model. In this example, clicking on a model group allows the user to “drill-down” to the more detailed accounts level, where account searches may be performed using the advanced search and content filter mechanisms described earlier in this document. Once the account and offering(s) have been selected, the user may then focus on the account offering match screen depicted in FIG. 13 to determine the resulting impact of allocating offered securities to the account.

By way of example, in the account offering match screen depicted in FIG. 13, the user has selected two offerings to be evaluated for the impact of their allocation to the account. By selecting the corresponding option from the “Allocate” box 1301, the user can allocate the offerings to the account in the amount of a specified quantity, or based on a specified percentage of total market value held in the account. The user can also manually specify allocation quantities for offerings by entering values in the “Qty” field 1313 for each offering. Offerings can be allocated to the account in the order in which they appear on the screen. Offerings can be re-allocated by re-sorting the offerings by any of the characteristics in the associated columns.

Using the exemplary compliance software application, when considering offerings allocations to an account, the user may run multiple iterations of a scenario in order to evaluate their appropriateness in terms of their impact on the account. Each allocation iteration produces scores for each offering, based on allocation quantities determined by the selected option within the “Score by Qty” box 1305, or manually entered quantities. Impact of these allocations to the account's score can be measured for each offering and shown in the “Change” column 1307. When allocating by target, as depicted in FIG. 13, account scores reflect an allocation quantity equal to the target quantity as shown in “Qty To Allocate” field 1303, regardless of whether the actual quantity offered is sufficient, and with each score determined independently from any other offerings in the scenario. This allows the comparison of offerings on an equal quantity basis. In this example, a target quantity of 3,000 will be allocated for each offering even though only a quantity of 900 bonds have actually been offered for the second offering (CUSIP: 155105GC). After allocating the offerings to the account in this scenario, the user could re-sort the offerings by the Change column 1307 in order to bring the offerings with greatest positive impact to the top of the list.

In this example, the “155105GC” offering has resulted in a change in the account's score of −4, reducing its total score to 78. This offering has produced a negative impact using the target quantity of 3,000. The scoring by target detail for the “155105GC” offering is shown in FIG. 13a. It indicates that the entire change is a result of the offering allocation moving the account further from its PTL target of a 6% Weighted Average Yield (WAY), as defined by the account's associated model.

After scoring by target and determining which offerings may be appropriate to allocate to the account, the user can evaluate if the proposal is still appropriate considering the actual quantity offered and the cash available in the account. When scoring by actual, as depicted in FIG. 13b, the user can allocate the indicated quantity of the offerings as shown in “Qty To Allocate” field 1303 (or the actual offering quantity of the offering as shown in the “Offer Qty” field 1311 if it is less) in the order in which they appear until all offerings have been allocated, or the account's cash balance has been exhausted. The actual quantities allocated are shown in the “Qty” field 1313. In this example, the “544623BT7” offering has a sufficient quantity offered and there is sufficient cash to result in 3,000 being allocated as desired, while “155105GC” is constrained by both the quantity being offered (900) and the remaining cash available in the account (750). The tighter constraint of the two, the remaining cash available, results in the actual allocation quantity of 750. Had there been sufficient cash in the account, the allocation quantity for the “155105GC” offering could have been 900. Allocating 750 of the “155105GC” offering results in a less negative impact on the account score as compared with the 3,000 target allocation described above, but FIG. 13c illustrates that WAY 1307 resulting from the proposal is still less than its current WAY 1309, and further away from the PTL target 1315 established by the account's associated model.

The exemplary compliance software application will also check whether the allocation conflicts with the model's parameters defined by the user, and can display indicia such as model flags. For example, referring to FIG. 13, despite the fact that allocating the “544623BT7” offering to the account shows a positive impact as shown by its change in score, it is also indicated through a model flag 1309 that this allocation conflicts with the PTLs' low limit related to WAY, and therefore may not be suitable for allocation to the account. Details of the PTL's limit violation are described in FIG. 13c.

5. Swap Match

Using the exemplary compliance software application, in the swap match scenario, the user can evaluate the impact of selling holdings from one or more accounts, and replacing them with a security being offered. The procedure to evaluate the selling of a security without replacement can work in essentially the same way.

Referring to FIG. 14, by selecting the “Swap Proposal” option from the “Workpad” menu 1400, the user of the exemplary compliance software application can launch a screen containing three windows as depicted in FIG. 14. To start a proposal, the user can select and drag holdings from one or more accounts listed in the holdings window 1401 and an offering from the offerings window 1403 and drop them on the swap match window 1405. The holdings window 1401 may initially display the highest level view of the account holdings, a summary of all holdings grouped by model. Preferably, clicking on a model group allows the user to “drill-down” to the more detailed holdings level, where security searches may be performed using the advanced search and content filter mechanisms described earlier in this document. Once the holding(s) and the offering have been thus selected and incorporated into the swap match window, the user can view the swap match screen depicted in FIG. 14a to determine if the purchase and/or sale(s) are appropriate.

By way of example, in the swap match screen depicted in FIG. 14a, the user has selected holdings of the same security (CUSIP: 011831ZJ6) from two accounts, and obtained an analysis of the impact on each of the accounts that would result if the holdings were sold and replaced with a corresponding par amount quantity of the offering (CUSIP: 069077CW3). In the exemplary compliance software application, by default, offerings are allocated to each account in par amount quantities equal to those of the holdings being considered for sale. However, the exemplary compliance software application enables the user to manually enter the quantities for both the buy and sale as he wants in the “Buy Qty” and “Sell Qty” fields 1407 and 1409 respectively.

In the swap match screen depicted in FIG. 14a, additional user inputs include Sell Tax Factor 1411 and Buy Tax Factor 1413. These inputs allow the user to evaluate the tax-adjusted impact of the swap proposal on yield and income. These user entered factors may depend on, for example, the securities' state of issuance and on the account holders' states of residency. For example, municipal bond income for bonds issued in the state of residence of an investor is often exempt from state tax. In the example depicted in FIG. 14a, it is implied that the offering bonds (CUSIP: 069077CW3) with a California-based issuer with tax factor of 0.96 afford a tax benefit to these accounts that the bond holdings (CUSIP: 011831ZJ6) with an Alaska-based issuer with tax factor 1.00 do not afford.

Still referring to FIG. 14a, the swap match screen may also include details on the impact to current cash position and annual bond income that would result from the potential transactions. For example, the “Cash Raised” column 1415 indicates the funds that would be received as a result of the sell; the “Cash Spent” column 1417 indicates the funds expended as a result of the buy, and the “Cash Change” column 1419 indicates the difference between the cash raised and cash spent. The “Income Change” column 1421 can be used to indicate the change in annual bond income that would result from the swap proposal.

Optionally but preferably, when considering a swap proposal, the user may run multiple iterations of a scenario in an effort to identify the holding changes that will most positively impact each account. Similar to the other proposal types, a measure of the impact of the swap proposal is indicated by the change in the score for each account. In addition to the detailed score analysis described previously for the other proposal types, the swap proposal score detail may contain additional measures as illustrated in FIG. 14b. These measures may include, for example, the differences between the effective maturity dates, security ratings, first call dates, and yearly income that would result from the swap, and any profit or loss that would result from the sale.

III. Communication Between Users

In accordance with one embodiment of the present invention, the exemplary compliance software provides the user with an interface that allows communication with other users of the electronic trading system 100 of FIG. 1. It provides the user with the tools to electronically search, receive and view offerings and new issuance of securities. It also enables the user to sell holdings and/or negotiate electronically as a buyer or seller.

1. Sell Holdings

The exemplary compliance software application provides an interface to allow communicating offerings and account holdings information to other users.

First, the exemplary compliance software application can provide a list of account holdings that the user has marked for sale. Referring to FIG. 15, using the holdings window 1501 provided by the exemplary compliance software application, the user can search for accounts that need to raise cash and choose a set of holdings that may be good sale candidates. Next, the user can drag the holdings from the “holdings” widow 1501 to the “holdings for sale” window 1503. Once the securities are on the holdings for sale window, the user can finalize his choices. From holdings for sale window 1503, the user can, for example, do one or more of the following:
(1) specify an offering status (e.g., active, inactive, or hidden);
(2) determine the quantity of the holding to offer by adjusting the offer field;
(3) search for like CUSIPs in other accounts, adding to his offering position;
(4) combine like CUSIPs for two or more offerings, consolidating his offering position;
(5) price his offerings by dollar price, yield, or spread (more on spread later in this document);
(6) specify a minimum block and multiples of parameters; or
(7) specify a restriction list establishing which users can view the offering.

Once the offering list has been established and parameters set, the user can then click the “Update Offerings” button 1505 to load/update his offerings to the service provider's web-server 130 of FIG. 1a. In a preferred embodiment, negotiations with other users are possible once the holdings are marked as active offerings on the website 135 by the user. If the user agrees to terms with a buyer, he can then mark the holdings as traded and produce trade tickets. Trading a holding will remove that line-item from the account, and increase the cash balance by the net amount indicated on the trade ticket.

Executed trades can also be entered in, or communicated to the user's accounting system of record, and reflected in the exemplary computer software application the next time the holdings ETL process is performed.

As described earlier, accounts within the software application of the present invention are client securities portfolios. FIG. 16 details an example of the portfolio area of the holdings-for-sale screen generated by the exemplary compliance software application. On this screen, the user can define a set of accounts and holdings he wants to make available for viewing by selected other system users. When making accounts available for viewing, the user is indicating that the account holdings are offered for sale upon request from a sell-side user. Similar to the steps described above to mark holdings-for-sale, the user can drag accounts from the holdings screen to the holdings-for-sale screen (portfolios section). Dragging the account to the holdings-for-sale screen creates a snap-shot of the account holdings. Once the account and holdings have been moved, the user has access to one or more of the following optional but preferred functions:
Specify a “public” account name, thereby protecting the anonymity of the user's clients.
Specify an expiration date in order to limit how long the account information will be available.
Specify a restriction list establishing which users can view the account holdings.

Using the exemplary compliance software application, after the account list and restriction parameters have been established, the user can click the “Update Portfolios” button 1601 of FIG. 16 to load/update his portfolios (accounts) on the service provider's web-server and website. Once on the web-server, the accounts are viewable by accessing the service provider's website by the list of users specified by the restriction list.

Preferably the compliance software application of the present invention enables the user to create sessions. “Sessions” as used in this specification refer to user offerings made exclusively to another specific user, typically a broker/dealer. This allows the user to, in effect, sub-contract the offering process for the selected securities, while providing him anonymity to end buyers with respect to his ownership of the offerings in the session. The broker/dealer is then free to make a “white-label” offering of the securities as if they were part of his own inventory. The broker/dealer will offer the securities from his inventory at a price greater than the price indicated in the session—the price at which he will buy the securities from the user. The broker/dealer's offering must still conform to the parameters (price, minimum block, etc.) specified by the user.

When creating a holdings list for a session, the user takes steps similar to the ones needed to add holdings to an offering list described earlier. To start a session, the user selects and drags account holdings from the holdings screen to the holdings for sale screen (sessions section). Once the Holdings have been added to the session, the user can finalize his choices and establish his offering parameters.

FIG. 17 shows an example of the sessions screen with some features described below. Using the sessions screen, the user can do the following:
Specify a session status 1701 (for example, active, closed, or suspended).
Specify another specific user, for example seller 1703, as the session recipient
Specify a session expiration time, limiting the availability of the offerings
Determine the quantity of the holding to offer by adjusting the offer field
Search for like holdings in other accounts, adding to his offering position
Combine like holdings for a group of offerings, consolidating his offering position within a session
Price his offerings by dollar price, yield, or spread (more on spread later in this document)
Specify minimum-block and multiples-of parameters.

After the sessions list and restriction parameters have been established, the user can click the “Update Sessions” button 1705 to load/update his sessions to the service provider's web-server. Once on the web-server, the sessions are viewable by accessing to the service provider's website by the seller 1703 specified in the session. The user can periodically check the session throughout the day to monitor the broker/dealer's progress in selling the holdings. As the broker/dealer sells holdings (or pieces of holdings), the sessions will be updated with the transaction information. The user can then produce individual trade tickets, or a “blended” ticket once the session has expired or has been completed.

2. Directed Offerings

Optionally but preferably, a software application of the present invention supports directed offerings, which are offerings sent to the user from sellers within the electronic trading system employing the present invention. Directed offering information can include, for example, a CUSIP number, brief description, par amount, quantity restrictions (multiples of, minimum block size), settle date, offering dollar price, and a link to a detailed security description. An exemplary directed offering screen is depicted in FIG. 18. Optionally but preferably, it functions as a “pop-up” window, appearing on top of other open windows on the user's personal computer. This “pop-up” functionality alerts the user of a new directed offering representing a potential buying opportunity. Using the exemplary compliance software application, the user can also access this screen by choosing “Directed Offerings” from the “Marketplace” menu 1901 as shown on FIG. 19.

In the example depicted in FIG. 18, a sell-side user has directed an offering of 500 CA bonds maturing in 2006 offered at a 5% yield to the buy-side user. From the directed offerings screen, the buy-side user can begin the evaluation process. He can view bond description data, delete the directed offering, or save it to the offering screen described in FIG. 8. Once the offering has been saved or imported to the offering screen of FIG. 8, the buy-side user can run various scenario analyses described earlier in this specification to determine if these offerings effectively match the demand within his accounts. Throughout the evaluation process, feedback is sent to the seller indicating through which steps the buy-side user has moved the offering.

Referring back to FIG. 1a, using the electronic trading system 100 of the present invention, the user can also electronically negotiate the terms of an offering by submitting and responding to a series of standard messages like bid, counter, order, etc. Communications are sent electronically between the buy-side user 101 and sell-side user 105 via the service provider's web-server 130 and website 135 until the terms have been agreed upon or the negotiation has been abandoned. The user 101 can engage in electronic negotiations for any offerings within the electronic trading system 100, including directed offerings, offerings found in a search, or for the holdings he has posted for sale.

In accordance with one embodiment of the present invention, the exemplary compliance software application offers buyers the option to electronically purchase bonds or negotiate price; but buyers can also negotiate or execute trades in a traditional way, for example verbally.

3. Search Functions

The system and method of the present invention provides strong search functionality to users. Referring to FIG. 1a and FIG. 19, the buy-side user 101 of FIG. 1a, using the exemplary compliance software application, can access the screen shown in FIG. 19 by selecting “Search BondWave” from the “Marketplace” menu 1901. Inputting security characteristics in the advanced search filter field 1903, the user can run searches for offerings that meet his accounts' demand specifications or their model characteristics. Once the user has selected a set of offerings from the search, he can then click the “Import Selected” button 1905 to import the offerings to the offerings “scratch-pad” described in FIG. 8. Once imported, the user can run various purchase and/or swap proposals to determine if the offerings are an appropriate-purchase for his accounts.

A distinguishing feature of the offering search functionality provided by a system employing the present invention is the ability to search by model and/or bond type. By defining a model, the user has established the acceptable characteristics of the securities held in an account or a group of accounts. Bond types are defined sets of security characteristics that are used to build models. Assigning a model to an account provides the user an investment framework to manage that account, and facilitates searching for acceptable offerings to potentially add to it. This interface allows the user to use the previously defined set of characteristics as defined by models or bond types to search for acceptable offerings.

The example in FIG. 19 shows the results of a search that yields a list of securities that meet the characteristics of the model entitled “NY 10 Year”. Based on the model, the search criteria were effectively entered as “NY bonds maturing in 10 years with Composite Issuer rating above BBB+.”

Using a software application of the present invention, the user can search new issuance of securities. Referring to FIG. 20, the user can access the “Search New Issuance” screen of the exemplary compliance software application by selecting “Search New Issuance” from the “Marketplace” menu 2001. Through this screen, the user can search all the deals on the service provider's web-server. Inputting deal and scale characteristics in the advanced search filter field 2003, the user can run searches for deals that meet his accounts' demand specifications. Once the user has selected a set of deals from the search, he can then select the set and click the “Import Selected” button 2005 to import the deals to the new issuance “scratch-pad” described in FIGS. 20 and 20a. Once imported, the user can run various purchase and/or swap proposals to determine if the scale items are an appropriate purchase for his accounts.

The example in FIG. 20 shows the results of a search that yields a list of CA deals. The examples in FIGS. 20a and 20b show scale information for the deal in different levels of detail. Using the exemplary compliance software application, the user can “drill-down” to these levels of detail by double-clicking on a deal in FIG. 20, and then clicking on the “Show Details” link 2007 in FIG. 20a, which will direct the user to the detailed scale information shown in FIG. 20b.

4. Yield Curve

A bond's yield is its annual percentage rate of return. It is a function of a bond's purchase price, coupon interest rate, and maturity. A yield curve represents a set of yields for a hypothetical set of securities with maturities, for example, from 1 to 30 years. The yield curve is a standard tool used by industry professionals to communicate their offerings or holdings prices. Optionally but preferably, a compliance software application of the present invention enables users to use a yield curve to communicate price information with each other. Once a yield curve has been mutually agreed to between two users, it becomes a pricing benchmark relative to which offerings and negotiations can take place. For example, a user may make a “+5” offering for a holding maturing in 2006. Referring to FIG. 21, the user is stating that his offering is five (5) basis points greater than the 2006 yield stated on the yield curve, or 1.95% yield. Stating offerings in this fashion simplifies communication and maintenance of offerings prices. Yield curve data may be loaded into a compliance software application through an ETL process.

While the invention has been described with reference to certain embodiments or examples, it will be understood by those skilled in the art that various changes may be made and equivalents may be substituted without departing from the scope of the invention. In addition, many modifications may be made to adapt a particular situation or securities market to the teachings of the invention without departing from its scope. Therefore, it is intended that the invention not be limited to the particular embodiments or exemplary system or software applications disclosed, but that the invention will include all embodiments falling within the scope of the appended claims.

1. A method for a user to manage portfolios of fixed income securities utilizing a computer, comprising:
creating one or more accounts by using the computer, wherein each account comprises one or more fixed income security holdings;
creating an investment model by using the computer, wherein the investment model is defined by a set of first parameters;
assigning the one or more accounts to the investment model by using the computer;
determining aggregate measures of characteristics of the security holdings in a selected account of the one or more accounts;
correlating the set of first parameters with the aggregate measures of the characteristics of the security holdings in the selected account and characteristics of each of the security holdings in the selected account;
generating in response to the correlating step measures of correlation by using the computer; and
displaying indicia of the measures of correlation by using the computer.

2. The method of claim 1, further comprising the step of:
(a) adding a fixed income security offering to the selected account;
(b) removing all or part of a fixed income security holding in the selected account; or
(c) a combination thereof.

3. The method of claim 2, wherein the step of correlation further includes a correlation of the set of first parameters with the addition of the security offering, the removal of all or part of the security holding, or the combination thereof.

4. The method of claim 1, further comprising the step of defining each of the one or more accounts with a set of second parameters.

5. The method of claim 4, wherein the step of correlation further includes a correlation to the set of second parameters of the selected account with the aggregate measures of the characteristics of the security holdings and the characteristics of each of the security holdings in the selected account.

6. The method of claim 5, further comprising:
(a) adding a fixed income security offering to the selected account;
(b) removing all or part of a fixed income security holding in the selected account; or
(c) a combination thereof.

7. The method of claim 6, wherein the step of correlation further includes a correlation of the sets of first and second parameters with (a) the addition of the security offering, (b) the removal of all or part of the security holding, or (c) the combination thereof.

8. The method of claim 4, wherein the sets of first and second parameters are based on bond types.

9. The method of claim 8, wherein the bond types are defined by one or more security characteristics.

10. The method of claim 1, wherein the first parameters comprise parameters defining acceptable fixed income security characteristics, parameters defining unacceptable fixed income security characteristics, parameters defining acceptable bounds for a measured characteristic of an assigned account; parameters defining a preferred value of a measured characteristic of an assigned account, or a combination thereof.

11. The method of claim 4, wherein the second parameters comprise parameters defining unacceptable fixed income security characteristics, parameters defining acceptable bounds for a measured characteristic of the account, parameters defining a preferred value of a measured characteristic of the account, or a combination thereof.

12. The method of claim 1, further comprising transferring model data of the investment model to a web-server of a service provider by using the computer, wherein the model data is accessible by another user via a computer communication network.

13. The method of claim 12, wherein the computer communication network is an Internet, wherein the model data comprises information selected from the group consisting of aggregate demand amount, description of fixed income securities as defined by the first parameters of the investment model, and a combination thereof.

14. The method of claim 1, further comprising searching fixed income security offerings in a market or fixed income security holdings in the one or more accounts.

15. The method of claim 14, wherein the searching is based on a selected bond type, a selected model definition, or a combination thereof.

16. The method of claim 14, wherein the searching is based on account characteristics.

17. The method of claim 14, wherein the searching is based on the aggregate measures of the characteristics of the security holdings in the selected account.

18. The methods of claim 2, wherein the offering is posted on a service provider's web-server.

19. The method of claim 2, wherein the offering is a directed offering sent via a service provider's web-server to the user.

20. The method of claim 2, wherein the offering is manually entered into the electronic trading system by using the computer.

21. The method of claim 2, wherein the offering is a new issuance.

22. The method of claim 3, further comprising:
generating a proposal for a transaction using the indicia of the measures of correlation.

23. The method of claim 22, further comprising:
saving the proposal and the indicia to provide a retained record of a basis for a trading decision.

24. The method of claim 22, further comprising:
enabling a locked condition of the proposal in response to the user's approval of the proposal and displaying indicia of the locked condition in connection with the security offering or holding.

25. The method of claim 22, further comprising:
enabling completion of the transaction.

26. The method of claim 22, further comprising:
generating e-mail messages describing impact of the transaction of the proposal upon the selected account; and
sending the e-mail messages to e-mail addresses associated with the selected account.

27. The method of claim 1 wherein generating the measures of correlation comprises:
identifying potential conflicts between the set of first parameters and the security holdings in the selected account; and
displaying indicia of the potential conflicts.

28. The method of claim 3, wherein generating the measures of correlation comprises:
identifying potential conflicts between the set of first parameters and the addition of the security offering; and
displaying indicia of the potential conflicts.

29. The method of claim 3, wherein generating the measures of correlation comprises:
identifying potential conflicts between the set of first parameters and the combination of the addition of the security offering and the removal of the security holding; and
displaying indicia of the potential conflicts.

30. The method of claim 5, wherein generating the measures of correlation comprises:
identifying potential conflicts between the set of first parameters or the set of second parameters of the selected account and the security holdings in the selected account; and
displaying indicia of the potential conflicts.

31. The method of claim 6, wherein generating the measures of correlation comprises:
identifying potential conflicts between the set of first parameters or the set of second parameters of the selected account and the addition of the security offering or the combination of the addition of the security offering and the removal of the security holding; and
displaying indicia of the potential conflicts.

32. The method of claim 1, wherein generating the measures of correlation comprises:
generating a numerical score indicating how well the set of first parameters correlate with the aggregate measures of the security holdings in the selected account; and
displaying indicia of the score.

33. The method of claim 3, wherein generating the measures of correlation comprises:
generating a numerical score indicating how well the set of first parameters correlate with the aggregate measures of the security holdings in the selected account resulting from (a) the addition of the security offering, (b) the removal of the security holding, or (c) the combination thereof; and
displaying indicia of the score.

34. The method of claim 5, wherein generating the measures of correlation comprises:
generating a numerical score indicating how well the sets of first and second parameters correlate with the aggregate measures of the security holdings in the selected account; and
displaying indicia of the score.

35. The method of claim 6, wherein generating the measures of correlation comprises:
generating a numerical score indicating how well the sets of first and second parameters correlate with the aggregate measures of the security holdings in the selected account resulting from (a) the addition of the security offering, (b) the removal of the security holding, or (c) the combination thereof; and
displaying indicia of the score.

36. The method of claim 3, wherein generating the measures of correlation comprises:
generating a first numerical score indicating how well the set of first parameters correlate with the selected account before (a) the addition of the security offering, (b) the removal of the security holding, or (c) the combination thereof;
generating a second numerical score indicating how well the set of first parameters correlate with the selected account after (a) the addition of the security offering, (b) the removal of the security holding, or (c) the combination thereof;
comparing the second numerical score to the first numerical score of the selected account; and
displaying the difference between the first and second numerical scores.

37. The method of claim 6, wherein generating the measures of correlation comprises:
generating a first numerical score indicating how well the sets of first and second parameters correlate with the selected account before (a) the addition of the security offering, (b) the removal of the security holding, or (c) the combination thereof;
generating a second numerical score indicating how well the sets of first and second parameters correlate with the selected account after (a) the addition of the security offering, (b) the removal of the security holding, or (c) the combination thereof;
comparing the second numerical score to the first numerical score of the selected account; and
displaying the difference between the first and second numerical scores.

38. A method for a user to manage portfolios of fixed income securities utilizing a computer, comprising:
creating a first investment model by using the computer, wherein the first investment model is defined by a first set of first parameters;
creating a plurality of accounts by using the computer, wherein each of the plurality of accounts comprises one or more fixed income security holdings, wherein each of the plurality of accounts has a set of second parameters defined; and
assigning one or more of the plurality of accounts to the first investment model by using the computer.

39. The method of claim 38, further comprising:
creating a second or more investment models by using the computer, wherein the second or more investment models are defined by a second or more sets of first parameters; and
assigning one or more of the plurality of accounts to each of the second or more investment models by using the computer.

40. The method of claim 38, wherein the set of second parameters of a selected account is blank.

41. The method of claim 38, wherein the fist and second parameters are based on bond types.

42. The method of claim 41, wherein the bond types are defined by one or more security characteristics.

43. The method of claim 41, further comprising searching for a kind of security holdings among one or more of the plurality of accounts or a kind of accounts among the plurality of accounts based on a selected bond type, a selected account type, a selected model definition, account characteristics, aggregate measures of characteristics of the security holdings in a selected account, or a combination thereof.

44. The method of claim 38, further comprising running an account report or a benchmark analysis.

45. The method of claim 44, wherein running the account report comprises:
correlating a selected account assigned to the first investment model with the set of second parameters of the selected account and the set of first parameters;
generating in response to the correlating measures of correlation; and
displaying the account report showing indicia of the measures of correlation.

46. The method of claim 45, wherein generating the measures of correlation comprises:
identifying a potential conflict between the first or second parameters and the selected account; and
providing indicia of the potential conflict in the account report.

47. The method of claim 45, wherein generating the measures of correlation comprises:
generating a numerical score indicating how well the sets of first and second parameters correlate with the selected account; and
providing indicia of the numerical score in the account report.

48. The method of claim 47, wherein the sets of first and second parameters provide one or more preferred account characteristic values for account characteristics of the selected account, wherein the numerical score is a composite measure based on the one or more preferred account characteristic values.

49. The method of claim 48, wherein generating a numerical score comprises:
calculating a difference between each preferred account characteristic value and each actual value of the selected account;
weighing the difference based on a unit measure assigned to each preferred account characteristic value;
determining an effect of the weighted difference on the numerical score based on a type assigned to each preferred account characteristic value; and
producing a composite measure based on the determined effects of the one or more preferred account characteristic values.

50. The method of claim 44, wherein running the benchmark analysis comprises:
assigning a benchmark to a selected account; and
comparing statistics within the selected account to statistics within the assigned benchmark.

51. The method of claim 38, further comprising transferring model data of the first investment model to a web-server of a service provider by using the computer, wherein the model data is accessible by another user via a computer communication network.

52. The method of claim 51, wherein the computer communication network is an Internet, wherein the model data comprises information selected from the group consisting of aggregate demand amount, description of fixed income security holdings assigned to the investment model, and a combination thereof.

53. The method of claim 51, further comprising setting up limits for dissemination of the model data to the web-server or other users of the web-server.

54. The method of claim 38, further comprising:
creating a list of holdings, wherein the list includes one or more fixed income security holdings in the plurality of accounts; and
offering the listed holdings for sale.

55. The method of claim 54, further comprising uploading the list of holdings to a service provider's web-server.

56. The method of claim 55, further comprising offering the holdings for sale exclusively to a selected user of the web-server.

57. The method of claim 56, wherein the selected user is a fixed income securities broker/dealer.

58. The method of claim 54, further comprising directing the list of holdings for sale to a selected user by using the computer.

59. The method of claim 38, further comprising:
selecting an offering, wherein the offering is a fixed income security offered for sale in a market;
selecting one or more of the plurality of accounts;
matching the offering to the selected accounts;
identifying one or more of the selected accounts that will be most positively impacted by allocation of the offering; and
allocating the offering to the identified accounts.

60. The method of claim 59, wherein the matching step comprises:
allocating a target quantity of the offering to each of the selected accounts, wherein the target quantity is a hypothetical quantity not limited by the actual quantity of the offering;
scoring each of the selected accounts before and after the allocation of the target quantity of the offering to give a score change for each account.

61. The method of claim 60, wherein the identifying step comprises comparing the score changes of all the selected accounts.

62. The method of claim 38, further comprising:
selecting one or more offerings, wherein the offerings are fixed income securities offered for sale in a market;
selecting an account;
matching the offerings to the selected account;
identifying one or more of the offerings that will most positively impact the selected account; and
allocating the identified offerings to the selected account.

63. The method of claim 62, wherein the matching step comprises:
allocating a target quantity of each of the one or more offerings to the selected account, wherein the target quantity is a hypothetical quantity not limited by the actual quantities of the offerings;
scoring the selected account before and after the allocation of the target quantity of each of the offerings to give a score change caused by the allocation of each offering.

64. The method of claim 63, wherein the identifying step comprises comparing the score changes caused by each of the offerings.

65. The method of claim 38, further comprising:
selecting a fixed income security holding from a selected account; and
evaluating the impact of the sale of all or part of the selected fixed income security holding on the selected account.

66. The method of claim 38, further comprising:
selecting a quantity of a fixed income security holding in a selected account;
selecting an offering of a fixed income security in a market;
evaluating the impact of replacing the quantity of the selected holding with the same or a different quantity of the selected offering on the selected account.

67. The method of claim 66, further comprising
selling the quantity of the fixed income security holding and buying the same or a different quantity of the offering for the selected account.

68. The method of claim 66, wherein the impact evaluated is an income-tax-adjusted impact.

69. A computer software application for a user to manage portfolios of fixed income securities, comprising a set of instructions that when executed by a computer allows the user to:
create an investment model, wherein the investment model is defined by a set of first parameters;
create a plurality of accounts, wherein each of the plurality of accounts comprises one or more fixed income security holdings, wherein each of the plurality of accounts is defined by a set of second parameters; and
assign one or more of the plurality of accounts to the investment model.

70. A computer software application of claim 69, wherein the set of instructions further allows the user to search for fixed income security offerings that are offered for sale in a market or fixed income security holdings in the plurality of accounts.

71. A computer software application of claim 70, wherein the set of instructions further allows the user to search the offerings or holdings by a model definition, a bond type, or a combination thereof.

72. A computer software application of claim 69, wherein the set of instructions further allows the user to propose, negotiate, or execute a sale or purchase of a fixed income security.

73. A computer software application of claim 69, wherein the set of instructions further causes the computer to correlate a selected account assigned to the investment model with the set of first parameters and the set of second parameters of the selected account.

74. A computer software application of claim 73, wherein the set of instructions further causes the computer to generate in response to the correlating measures of correlation.

75. A computer software application of claim 74, wherein the set of instructions further causes the computer to display indicia of the measures of correlation.

76. A computer software application of claim 69, wherein the set of instructions further causes the computer to correlate a selected account resulting from (a) an addition of a fixed income security offering offered for sale in a market, (b) a removal of a fixed income security holding in the selected account assigned to the investment model, or (c) a combination thereof with the set of first parameters and the set of second parameters of the selected account.

77. A computer software application of claim 76, wherein the set of instructions further causes the computer to generate in response to the correlating measures of correlation.

78. A computer software application of claim 77, wherein the set of instructions further causes the display of indicia of the measures of correlation.
